(19) United States
(12) Patent Application Publication
(10) Pub. No.: US 2015/0121301 A1
(43) Pub. Date: Apr. 30, 2015

(54) INFORMATION PROCESSING METHOD AND ELECTRONIC DEVICE

(71) Applicant: Lenovo (Beijing) Co., Ltd., Beijing (CN)

(72) Inventor: Chao Wang, Beijing (CN)

(73) Assignee: Lenovo (Beijing) Co., Ltd., Beijing (CN)

(21) Appl. No.: 14/229,917

(22) Filed: Mar. 30, 2014

(30) Foreign Application Priority Data
Oct. 28, 2013 (CN) 201310516854.0
Oct. 28, 2013 (CN) 201310517102.6

(51) Int. Cl. G06F 3/0481; G06F 3/0488

(52) U.S. Cl. CPC G06F 3/0481; G06F 3/0488
USPC 715/790; 715/781

(57) ABSTRACT

An information processing method and an electronic device are provided. The method includes: initiating an application of the M applications in a non-full-screen window, obtaining a first parameter, and transforming a first window of the application into a second window of the application by using the first parameter, wherein the first window is a full-screen window, and a display region of the second window is smaller than a display region of the full-screen window of the application; presenting the second window of the application in the display region; detecting a first operation of a user to obtain a first event; and in response to the first event, determining a target window from the M windows according to a preset rule, distributing the first event to the target window, where an application corresponding to the target window responds to the first operation.

This application claims the priorities to Chinese Patent Application No. 201310517102.6.0, entitled “INFORMATION PROCESSING METHOD AND ELECTRONIC DEVICE”, filed with the Chinese Patent Office on Oct. 28, 2013; and Chinese Patent Application No. 201310516854.0, entitled “INFORMATION PROCESSING METHOD AND ELECTRONI DEVICE”, filed with the Chinese Patent Office on Oct. 28, 2013, which are incorporated by reference in their entireties herein.

### FIELD

The present disclosure relates to the field of communication technology, and in particular to an information processing method and an electronic device.

### BACKGROUND

The portable electronic device with various functions is more and more widely adopted by users, which enriches user's experience. In view of portability, the portable electronic device used by the user in daily operation is generally designed to have a small screen. For example, when the portable electronic device is a mobile phone, the screen of the mobile phone is generally designed to be in 3.5 inches, which is thus convenient for the user to carry.

However, in the existing technology, there are at least the following technical problems.

Taking a mobile phone as an example of the electronic device, in an existing information processing method, when multiple application programs run on the mobile phone, the operation system allows only one application program to run in a foreground, and only one application program may be displayed in a single window. That is, an operation system, such as Android operation system, of the mobile phone only provides the single window function. As a rise of smart phone, the screen of the mobile phone is prone to larger and larger, and thus it is possible for the mobile phone to support multiple-window display.

In the case where multiple windows are displayed in a display region, a user operation, such as a user key-pressing operation, is acquired. Since multiple-window display is supported, it is difficult to determine which windows the user key-pressing operation is distributed to. Hence, it is necessary to determine reasonably a target window from multiple windows, and distribute the key-pressing event to the target window. In the related art, there is no effective solution for the problem.

In addition, the user may open multiple small windows at one time in the mobile device, and each application is displayed and operated on the corresponding small window. However, when an operation interface with the multiple-window is used and both windows are overlapped, it is difficult to determine the window corresponding to the touch operation. In the way, it may cause a mass of operation, thereby impacting the user experiment.

### SUMMARY

In view of the above, an information processing method and an electronic device are provided, to solve at least the problem that it is difficult to determine which windows the user distributes the key pressing operation to.

According to an aspect of the disclosure, an information processing method is provided, which is applied to an electronic device with a touch display unit, and M windows corresponding to M applications are displayed at the touch display unit, where M is a positive integer, and the M windows includes at least one non-full-screen window. The method includes:

initiating an application of the M applications in the non-full-screen window, obtaining a first parameter, and transforming a first window of the application into a second window of the application by using the first parameter, wherein the first window is a full-screen window, and a display region of the second window is smaller than a display region of the full-screen window of the application;

presenting the second window of the application in the touch display unit;

detecting a first operation of a user to obtain a first event; and

in response to the first event, determining a target window from the M windows according to a preset rule, distributing the first event to the target window, where an application corresponding to the target window responds to the first operation.

According to another aspect of the discloser, an electronic device is provided, which includes a touch display unit. The touch display unit includes a display region, M windows corresponding to M applications are displayed at the display region, where M is a positive integer, and the M windows includes at least one non-full-screen window. The electronic device further includes:

a first processing unit adapted to initiate an application of the M applications in the non-full-screen window, obtain a first parameter, and transform a first window of the application into a second window of the application by using the first parameter, wherein the first window is a full-screen window, and a display region of the second window is smaller than a display region of the full-screen window of the application;

the touch display unit adapted to present the second window of the application in the display region;

a first obtaining unit adapted to detect a first operation of a user to obtain a first event; and

a first response unit adapted to in response to the first event, determine a target window from the M windows according to a preset rule, and distribute the first event to the target window, where an application corresponding to the target window responds to the first operation.

The method according to the disclosure includes: initiating an application of the M applications in a non-full-screen window, obtaining a first parameter, and transforming a first window of the application into a second window of the application by using the first parameter, wherein the first window is a full-screen window, and a display region of the second window is smaller than a display region of the full-screen window of the application; presenting the second window of the application in the display region; detecting a first operation of a user to obtain a first event; and in response to the first event, determining a target window from the M windows according to a preset rule, distributing the first event to the target window, where an application corresponding to the target window responds to the first operation.

According to the disclosure, in the case where the multiple-window display is supported, a first operation of the user is detected and a first event is obtained. In response to the first event, a target window is determined from the M windows according to a preset rule. The first event is distributed to the target window, and the application corresponding to the target window makes a response to the first operation. Therefore, a target window may be determined from multiple windows reasonably, to distribute the key-pressing event to the target window. Hence, at least the problem that it is difficult to determine which windows the user distributes the key pressing operation to is solved.

### BRIEF DESCRIPTION OF THE DRAWINGS

FIG. 1 is a schematic diagram showing a flowchart of a method according to an embodiment of the disclosure;

FIG. 2 is a schematic diagram showing multiple-window display according to an embodiment of the disclosure;

FIG. 3 is a schematic diagram showing a flowchart of a method according to an embodiment of the disclosure;

FIG. 4 is a schematic diagram showing a flowchart of a method according to an embodiment of the disclosure;

FIG. 5 is a schematic diagram showing a flowchart of a method according to an embodiment of the disclosure;

FIG. 6 is a schematic diagram showing a flowchart of a method according to an embodiment of the disclosure;

FIG. 7 is a schematic diagram showing a flowchart of a method according to an embodiment of the disclosure;

FIG. 8 is a schematic structural diagram showing an electronic device according to an embodiment of the disclosure; and

FIG. 9 is a schematic structural diagram showing an electronic device according to an embodiment of the disclosure.

### DETAILED DESCRIPTION

In the following, the implementation of the technical scheme is further described in detail in conjunction with the accompanying drawings.

### First Embodiment of a Method

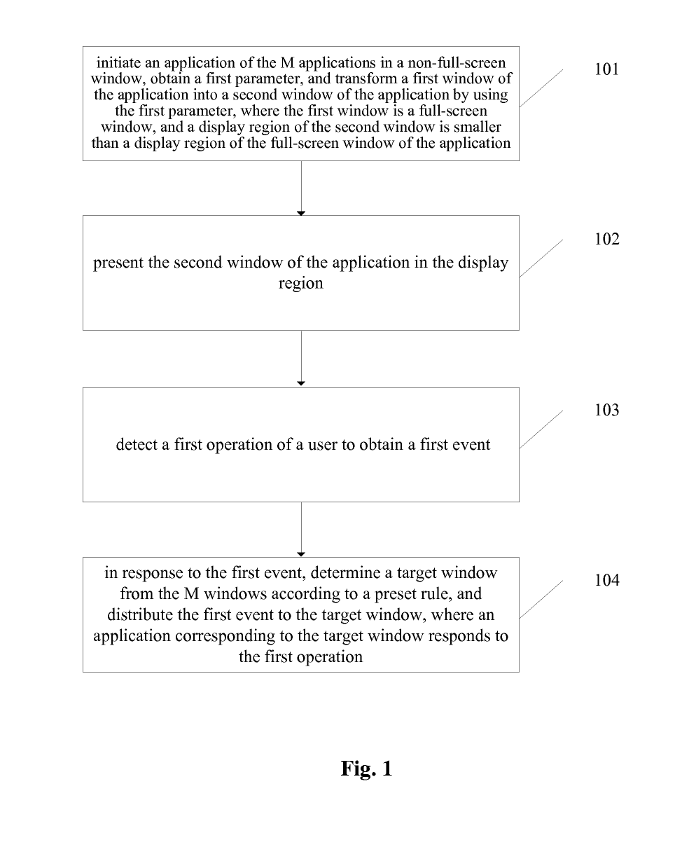

An information processing method according to an embodiment of the disclosure is applied to an electronic device which includes a touch display unit. The touch display unit includes a display region, and M windows corresponding to M applications are displayed at the display region, where M is a positive integer. The M windows includes at least one non-full-screen window in the M windows. As shown in FIG. 1, the method includes Steps 101-104.

Step 101 is to initiate an application of the M applications in a non-full-screen window, obtain a first parameter, and transform a first window of the application into a second window of the application by using the first parameter, where the first window is a full-screen window, and a display region of the second window is smaller than a display region of the full-screen window of the application.

It should be noted that the first parameter is a transformation parameter for a window transformation, which may be at least one of:

a parameter value, a matrix, a parameter group and a parameter set.

When the first parameter is the matrix, the matrix may be referred to as a first transformation matrix. In order to simplify the description, the first transformation matrix is referred to as a first matrix in the following embodiments.

Step 102 is to present the second window of the application in the display region.

Step 103 is to detect a first operation of a user to obtain a first event.

Step 104 is to in response to the first event, determine a target window from the M windows according to a preset rule, and distribute the first event to the target window, where an application corresponding to the target window responds to the first operation.

With the method according to the embodiment of the disclosure, there are advantages as follows.

The first window is transformed into the second window by using the first parameter in Step 101, and the second window is adapted to replace the first window. In this way, the application is displayed in the second window. The display region of the second window, which is a non-full-screen window (or referred to as a small window), is smaller than the display region of the full-screen window of the application. In the case where the first parameter is the matrix, the non-full screen window is obtained by a matrix transformation; and thus the multiple-window display is supported better.

Compared to the existing technologies, the method is described by taking mobile phone as an example of the electronic device. As the rise of smart phones, the screen design of the mobile phone is prone to larger and larger. Thus, it is possible for the mobile phone to support multiple-window display. Here, the window refers to a window where an application program running on the mobile phone is displayed, which will not be described hereinafter.

However, in the existing technologies, when multiple application programs run on the mobile phone, a currently operated application in the applications is displayed in the foreground, that is, only one application window is displayed in the foreground on the screen of the mobile phone; and other applications are all displayed in the background, that is, other application windows are all displayed in the background. If one of the applications in the background needs to be displayed, it is necessary to switch the application window in the foreground currently to them. That is, in the existing technologies, although multiple application programs run at the same moment, only one application window is in an activated state on the screen of the mobile phone. Hence, a user may only read content information of the application displayed in the application window, which leads to a poor user experience and is inconvenient for the operation of the user. In addition, an operation for frequently switching between the application window in the foreground and the application window in background may also occupy a quantity of system resources. In the embodiment of the disclosure, the first application may be initiated in the non-full-screen window, so that the first application is displayed in the display region in a form of a window. That is, with the method according to the embodiment of the disclosure, multiple-window display may be supported, and thus multiple applications are displayed in multiple windows respectively. The multiple applications are all displayed in the foreground, which is not necessary to be switched between the foreground and the background. In this way, it is convenient for the operation of the user; and the occupation of a quantity of system resources is avoided, which is resulted by the operation of frequently switching between the window in the foreground and the window in the background. Here, the first application initiated in a non-full-screen window may be a first application initiated in a small window.

In the case where the multiple-window display is supported, the first operation of the user is detected to obtain the first event. In response to the first event, a target window is determined from the M windows according to a preset rule. The first event is distributed to the target window, and the application corresponding to the target window makes response to the first operation. Therefore, a target window may be determined from multiple windows reasonable, to distribute the key-pressing event to the target window. Hence, it is solved at least the problem that it is difficult to determine which windows the user distributes the key pressing operation to.

In a preferable embodiment of the disclosure, the first parameter in Step 101 is the matrix, and the method further includes:

reading graphic cache data of the application;

transforming, by using the first matrix, the read graphic cache data corresponding to the first window into graphic cache data corresponding to the second window; and incorporating the graphic cache data of the second window to obtain frame cache data of the touch display unit; and

displaying the second window of the application in the touch display unit by the frame cache data, in which the second window is used to replace the first window, to display the application in the second window.

In the following, Step 101 is further described by assuming that two applications are displayed in the second window respectively, that is, the two applications are displayed in non-full-screen windows respectively.

Step 101a is to read graphic cache data of the first window of an application.

The two applications write into a graphic cache the data drawn by itself for the full screen display. The graphic cache data includes coordinate information of pixels and Red Green Blue (RGB) information of pixels.

Step S101b is to transform, by using the first matrix, the read graphic cache data corresponding to the first window into graphic cache data corresponding to the second window, and incorporating the graphic cache data corresponding to the second window into frame cache data corresponding to the touch display unit.

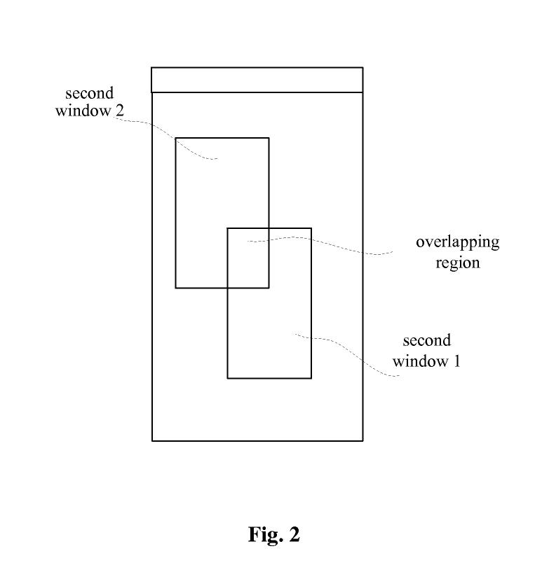

There is an overlapping region of the second windows. As shown in FIG. 2, there is an overlapping region of the second windows 1 and 2. In the embodiment, an two-dimensional coordinate (xₒ, yₒ) for marking a pixel point in the graphic cache data of the first window is expanded into a three-dimensional coordinate (xₒ, yₒ, zₒ), and different second windows has different zₒ in the third dimensional coordinates. Therefore, different second windows may be distinguished with different third dimensional coordinates, and a coverage relationship between the overlapping regions of the display regions of different second windows is determined. For example, in the case where there is the overlapping region between the second windows 1 and 2, if the third dimensional coordinate of the second window 2 is farther from the origin of the coordinate system than the third dimensional coordinate of the second window 1, then it is represented that a part of display region of the second window 1 is covered by the second window 2, and the overlapping region of the second windows 1 and 2 is used to display a part of contents of an application corresponding to the second window 2.

In the related art, the graphic cache data read in Step 101a is incorporated with graphic cache data corresponding to a conventional display application (such as a status bar) in the electronic device to obtain the frame cache data, that is, the content to be displayed by the electronic device in a full screen. Thereby, in the embodiment, the expanded three-dimensional coordinate (xₒ, yₒ, zₒ) in the graphic cache data is transformed by using the first matrix, and then the full-screen window, i.e. the first window, of the application may be transformed into the second window, i.e. the non-full-screen window. The transformed graphic cache data includes transformed (xₒ, yₒ, zₒ) and the RGB information of the corresponding pixel point.

Assuming that the first window is transformed into the second window by scaling down the first window by ½. The corresponding first matrix is

$$( \begin{matrix}1 / 2 & 0 & 0 \\ 0 & 1 / 2 & 0 \\ 0 & 0 & 1 / 2\end{matrix} ) ,$$

and three-dimensional coordinates (xₜ, yₜ, zₜ) of pixel points in the frame cache data corresponding to the second window are expressed as equation (1):

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) . \qquad ( 1 )$$

Assuming that the first window is transformed into the second window by scaling down the first window by ½ and then translating the first window by Δ x in the horizontal direction and Δ y in a vertical direction. The corresponding first matrix is

$$( \begin{matrix}1 / 2 & 0 & Δ x \\ 0 & 1 / 2 & Δ y \\ 0 & 0 & 1 / 2\end{matrix} ) ,$$

and the three-dimensional coordinates (xₜ, yₜ, zₜ) of pixel points in the frame cache data corresponding to the second window are expressed as equation (2):

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) . \qquad ( 1 )$$

Assuming that the first window is transformed into the second window by scaling down the first window by ½, and then rotating the first window clockwise by an angle θ. The corresponding first matrix is

$$( \begin{matrix}cos θ / 2 & 0 & 0 \\ 0 & cos θ / 2 & 0 \\ 0 & 0 & cos θ / 2\end{matrix} ) ,$$

and the three-dimensional coordinates (xₜ, yₜ, zₜ) of pixel points in the frame cache data corresponding to the second window are expressed as equation (3):

$$( {x}_{t} , {y}_{t} , {z}_{t} ) = ( \begin{matrix}cos θ / 2 & 0 & 0 \\ 0 & cos θ / 2 & 0 \\ 0 & 0 & cos θ / 2\end{matrix} ) \times ( \begin{matrix}{x}_{o} \\ {y}_{o} \\ {z}_{o}\end{matrix} ) \qquad ( 3 )$$

In a practical application, when the first window is transformed into the second window at the first time, an initial position of the second window in the touch display unit may be preset. Information of a region specified by an electronic device user in the touch display unit of the electronic device may be acquired by an interactive operation, and the specified region is regarded as a display region of the second window. After the second window is displayed, a touch operation for scaling, moving or rotating the second window is received. The touch operation is parsed for corresponding parameters for the zooming, moving or rotating. Then Step 101c is performed.

Step 101c is to display the second window of the application in the touch display unit by using the frame cache data, in which the second window is used to replace the first window, to display the application in the corresponding second window.

In the following embodiments, in the case where multiple-window display is supported and the multiple windows includes at least one non-full-screen window, when the first parameter is the matrix, the non-full-screen window may also be obtained by the transformation matrix. That is, the first window is transformed by using the first matrix to determine the second window for replacing the first window, and thus the application is displayed in the second window, which will not be described hereinafter.

### Second Embodiment of a Method

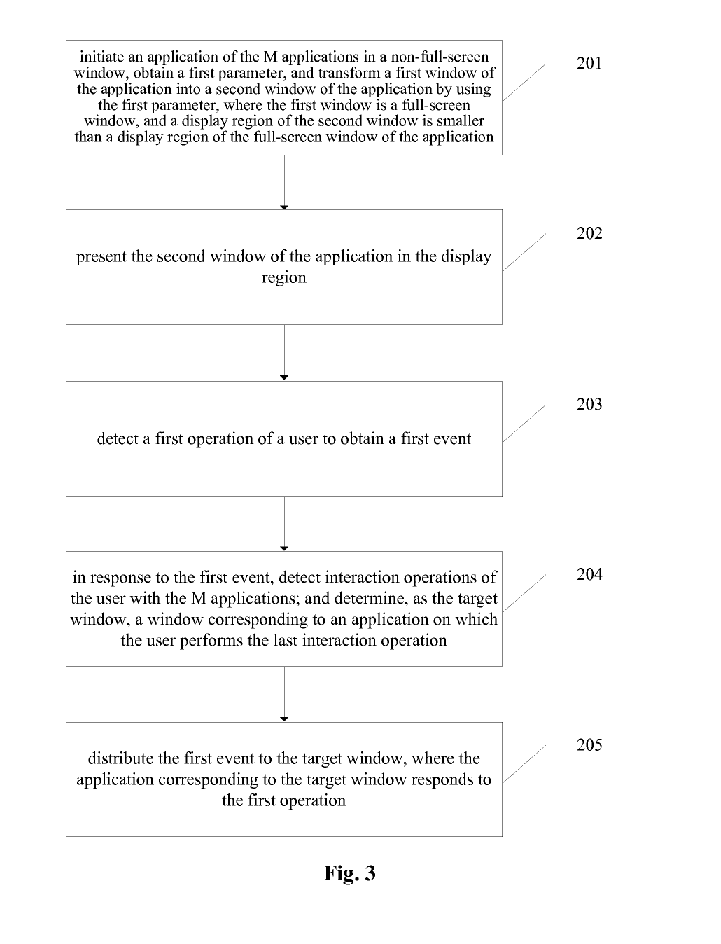

An information processing method according to an embodiment of the disclosure is applied to an electronic device which includes a touch display unit. The touch display unit includes a display region, and M windows corresponding to M applications are displayed at the display region, where M is a positive integer. The M windows includes at least one non-full-screen window in the M windows. As shown in FIG. 3, the method includes Steps 201-205.

Step 201 is to initiate an application of the M applications in a non-full-screen window, obtain a first parameter, and transform a first window of the application into a second window of the application by using the first parameter, where the first window is a full-screen window, and a display region of the second window is smaller than a display region of the full-screen window of the application.

The first parameter is a transformation parameter for a window transformation, which may be at least one of the followings:

a parameter value, a matrix, a parameter group and a parameter set.

In the case where the first parameter is the matrix, the matrix may be referred to as a first transformation matrix. In order to simplify the description, the first transformation matrix is referred to as a first matrix in the following embodiments.

Step 202 is to present the second window of the application in the display region.

Step 203 is to detect a first operation of a user to obtain a first event.

Step 204 is to in response to the first event, detect interaction operations of the user with the M applications; and determine, as the target window, a window corresponding to an application on which the user performs the last interaction operation.

Step 205 is to distribute the first event to the target window, where the application corresponding to the target window responds to the first operation.

With the method according to the embodiment of the disclosure, there are advantages as follows.

The first window is transformed into the second window by using the first parameter in Step 201, and the second window is adapted to replace the first window. In this way, the application is displayed in the second window. The display region of the second window, which is a non-full-screen window (or referred to as a small window), is smaller than the display region of the full-screen window of the application. In the case where the first parameter is the matrix, the non-full-screen window is obtained by a matrix transformation; thereby the multiple-window display is supported better.

Compared to the existing technologies, the method is described by taking mobile phone as an example of the electronic device. As the rise of smart phones, the screen design of the mobile phone is prone to larger and larger. Thus it is possible for the mobile phone to support multiple-window display. Here, the window refers to a window where an application program running on the mobile phone is displayed, which will not be described hereinafter.

However, in the existing technologies, when multiple applications run on the mobile phone, a currently operated application in the applications is displayed in the foreground, that is, on the screen of the mobile phone, there is only one application window is displayed in the foreground; and other applications are all displayed in the background, that is, other application windows are all displayed in the background. If one of the applications in the background needs to be displayed, it is necessary to switch the application window in the foreground currently to them. That is, in the existing technologies, although multiple applications run at the same moment, only one application window is in an activated state on the screen of the mobile phone. Hence, a user may only read content information of the application displayed in the application window, which leads to a poor user experience and is inconvenient for the operation of the user. In addition, an operation for frequently switching between the application window in the foreground and the application window in background may also occupy a quantity of system resources. In the embodiment of the disclosure, the first application may be initiated in the non-full-screen window, so that the first application is displayed in the display region in a form of a window. That is, with the method according to the embodiment of the disclosure, multiple-window display may be supported, and thus multiple applications are displayed in multiple windows respectively. The multiple applications are all displayed in the foreground, which is not necessary to be switched between the foreground and the background. In this way, it is convenient for the operation of the user, and the occupation of a quantity of system resources is avoided, which is resulted by the operation of frequently switching between the window in the foreground and the window in the background. Here, the first application initiated in a non-full-screen window may be a first application initiated in a small window.

In the case where the multiple-window display is supported, the first operation of the user is detected to obtain the first event. In response to the first event, in Step 204 of the embodiment of the disclosure, an interaction operation of the user with the M applications is detected and a window corresponding to an application on which the user performs the last interaction operation is determined as the target window. One target window can be determined from multiple windows reasonably. It is because that: when the first event such as a user key-press operation or a touch operation is generally triggered, the first event is transmitted to a window using by the user currently. The window using by the user currently can be acquired by detecting the interaction operation of the user with the M applications. The first event is distributed to the target window and the application corresponding to the target window makes response to the first operation. Therefore, a target window may be determined from multiple windows reasonable, to distribute the key-pressing event to the target window. Hence, it is solved at least the problem that it is difficult to determine which windows the user distributes the key pressing operation to.

### Third Embodiment of a Method

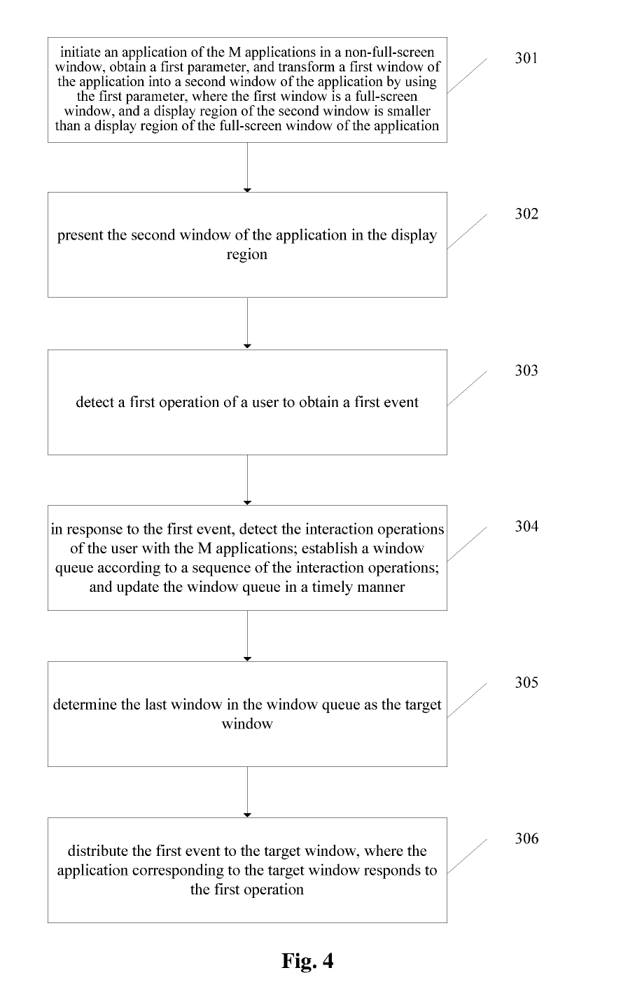

An information processing method according to an embodiment of the disclosure is applied to an electronic device which includes a touch display unit. The touch display unit includes a display region, and M windows corresponding to M applications are displayed at the display region, where M is a positive integer. The M windows includes at least one non-full-screen window in the M windows. As shown in FIG. 4, the method includes Steps 301-306.

Step 301 is to initiate an application of the M applications in a non-full-screen window, obtain a first parameter, and transform a first window of the application into a second window of the application by using the first parameter, where the first window is a full-screen window, and a display region of the second window is smaller than a display region of the full-screen window of the application.

The first parameter is a transformation parameter for a window transformation, which may be at least one of the followings:

a parameter value, a matrix, a parameter group and a parameter set.

In the case where the first parameter is the matrix, the matrix may be referred to as a first transformation matrix. In order to simplify the description, the first transformation matrix is referred to as a first matrix in the following embodiments.

Step 302 is to present the second window of the application in the display region.

Step 303 is to detect a first operation of a user to obtain a first event.

Step 304 is to in response to the first event, detect the interaction operations of the user with the M applications; establish a window queue according to a sequence of the interaction operations; and update the window queue in a timely manner.

Step 305 is to determine the last window in the window queue as the target window.

The last window in the window queue indicates information of a window located at a rear of the window queue.

Step 306 is to distribute the first event to the target window, where the application corresponding to the target window responds to the first operation.

With the method according to the embodiment of the disclosure, there are advantages as follows.

The first window is transformed into the second window by using the first parameter in Step 301, and the second window is adapted to replace the first window. In this way, the application is displayed in the second window. The display region of the second window, which is a non-full-screen window (or referred to as a small window), is smaller than the display region of the full-screen window of the application. In the case where the first parameter is the matrix, the non-full-screen window is obtained by a matrix transformation; thereby the multiple-window display is supported better.

Compared to the existing technologies, the method is described by taking mobile phone as an example of the electronic device. As the rise of smart phones, the screen design of the mobile phone is prone to larger and larger. Thus it is possible for the mobile phone to support multiple-window display. Here, the window refers to a window where an application running on the mobile phone is displayed, which will not be described hereinafter.

However, in the existing technologies, when multiple applications run on the mobile phone, a currently operated application in the applications is displayed in the foreground, that is, on the screen of the mobile phone, only one application window is displayed in the foreground; and other applications are all displayed in the background, that is, other application windows are all displayed in the background. If one of the applications in the background needs to be displayed, it is necessary to switch the application window in the foreground currently to them. That is, in the existing technologies, although multiple applications run at the same moment, only one application window is in an activated state on the screen of the mobile phone. Hence, a user may only read content information of the application displayed in the application window, which leads to a poor user experience and is inconvenient for the operation of the user. In addition, an operation for frequently switching between the application window in the foreground and the application window in background may also occupy a quantity of system resources. In the embodiment of the disclosure, the first application may be initiated in the non-full-screen window, so that the first application is displayed in the display region in a form of a window. That is, with the method according to the embodiment of the disclosure, multiple-window display may be supported, and thus multiple applications are displayed in multiple windows respectively. The multiple applications are all displayed in the foreground, which is not necessary to be switched between the foreground and the background. In this way, it is convenient for the operation of the user; and the occupation of a quantity of system resources is avoided, which is resulted by the operation of frequently switching between the window in the foreground and the window in the background. Here, the first application initiated in a non-full-screen window may be the first application initiated in a small window.

In the case where the multiple-window display is supported, the first operation of the user is detected to obtain the first event. In response to the first event, in Steps 304 to 305 of the embodiment of the disclosure, interaction operations of the user with the M applications are detected, a window queue is established according to the sequence of the interaction operations. The window queue is updated in a timely manner and a last window in the window queue is determined as the target window. One target window can be determined from multiple windows reasonably. It is because that: when the first event such as a user key-press operation or a touch operation is generally triggered, the first event is transmitted to a window using by the user currently. The window using by the user currently can be acquired precisely by detecting the interaction operations of the user with the M applications. The window corresponding to the application on which the user performs the last interaction operation may be determined well by introducing the window queue, so that the target window determined by detection is optimized. The first event is distributed to the target window and the application corresponding to the target window makes response to the first operation. Therefore, a target window may be determined from multiple windows reasonable, to distribute the key-pressing event to the target window. Hence, it is solved at least the problem that it is difficult to determine which windows the user distributes the key pressing operation to.

### Fourth Embodiment of a Method

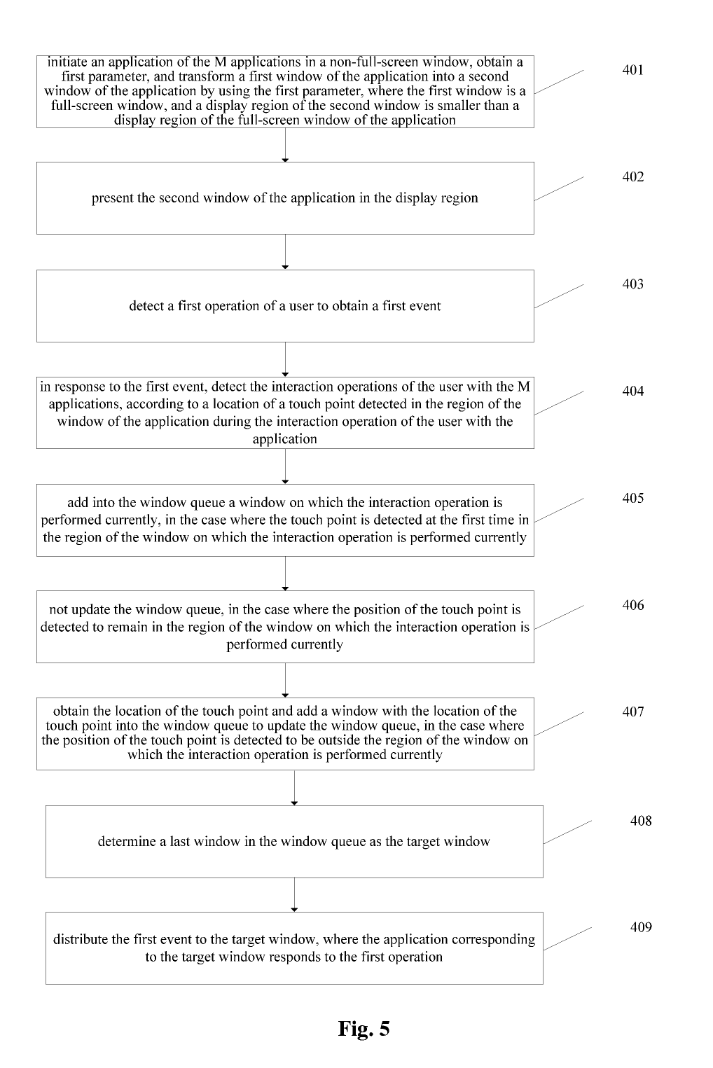

An information processing method according to an embodiment of the disclosure is applied to an electronic device which includes a touch display unit. The touch display unit includes a display region, and M windows corresponding to M applications are displayed at the display region, where M is a positive integer. The M windows includes at least one non-full-screen window in the M windows. As shown in FIG. 5, the method includes Step 401 to Step 409.

Step 401 is to initiate an application of the M applications in a non-full-screen window, obtain a first parameter, and transform a first window of the application into a second window of the application by using the first parameter, where the first window is a full-screen window, and a display region of the second window is smaller than a display region of the full-screen window of the application.

The first parameter is a transformation parameter for a window transformation, which may be at least one of the followings:

a parameter value, a matrix, a parameter group and a parameter set.

In the case where the first parameter is the matrix, the matrix be referred to as a first transformation matrix. In order to simplify the description, the first transformation matrix is referred to as a first matrix in the following embodiments.

Step 402 is to present the second window of the application in the display region.

Step 403 is to detect a first operation of a user to obtain a first event.

Step 404 is to in response to the first event, detect the interaction operations of the user with the M applications, according to a location of a touch point detected in the region of the window of the application during the interaction operation of the user with the application.

Step 405 is to add into the window queue a window on which the interaction operation is performed currently, in the case where the touch point is detected at the first time in the region of the window on which the interaction operation is performed currently.

Step 406 is to not update the window queue, in the case where the position of the touch point is detected to remain in the region of the window on which the interaction operation is performed currently.

Step 407 is to obtain the location of the touch point and add a window with the location of the touch point into the window queue to update the window queue, in the case where the position of the touch point is detected to be outside the region of the window on which the interaction operation is performed currently.

Step 408 is to determine a last window in the window queue as the target window.

Step 409 is to distribute the first event to the target window, where the application corresponding to the target window responds to the first operation.

With the method according to the embodiment of the disclosure, there are advantages as follows.

The first window is transformed into the second window by using the first parameter in Step 401, and the second window is adapted to replace the first window. In this way, the application is displayed in the second window. The display region of the second window, which is a non-full-screen window (or referred to as a small window), is smaller than the display region of the full-screen window of the application. In the case where the first parameter is the matrix, the non-full screen window is obtained by matrix transformation; thereby the multiple-window display is supported better.

Compared to the existing technologies, the method is described by taking the mobile phone as an example of the electronic device. As the rise of smart phones, the screen design of the mobile phone is prone to larger and larger. Thus it is possible for the mobile phone to support multiple-window display. Herein, the window refers to a window where an application running on the mobile phone is displayed, which will not be described hereinafter.

However, in the existing technologies, when multiple applications run on the mobile phone, a currently operated application in the applications is displayed in the foreground, that is, on the screen of the mobile phone, only one application window is displayed in the foreground; and other application programs are all displayed in the background, that is, other application windows are all displayed in the background. If one of the applications in the background needs to be displayed, it is necessary to switch the application window in the foreground currently to them. That is, in the existing technologies, although multiple applications run at the same moment, only one application window is in an activated state on the screen of the mobile phone. Hence, a user may only read content information of the application displayed in the application window, which leads to a poor user experience and is inconvenient for the operation of the user. In addition, an operation for frequently switching between the application window in the foreground and the application window in background frequently may also occupy a quantity of system resources. In the embodiment of the disclosure, the first application may be initiated in the non-full-screen window, so that the first application is displayed in the display region in a form of a window. That is, with the method according to the embodiment of the disclosure, multiple-window display may be supported, and thus multiple applications are displayed in multiple windows respectively. The multiple applications are all displayed in the foreground, which is not necessary to be switched between the foreground and the background. In this way, it is convenient for the operation of the user; and the occupation of a quantity of system resources is avoided, which is resulted by frequently switching between the window in the foreground and the window in the background. Herein, the first application initiated in a non-full-screen window may be the first application initiated in a small window.

In the case where the multiple-window display is supported, the first operation of the user is detected to obtain the first event. In response to the first event, in Steps 404 to Step 407 of the embodiment of the disclosure, interaction operations of the user with the M applications are detected, a window queue is established according to the sequence of the interaction operations. The window queue is updated in a timely manner. The method for detecting the interaction operations includes: detecting the touch point. Herein, it should be noted that, the region of the window of the current interaction operation is a region of the non-full-screen window, and thus the method for detecting the location of the touch point is different from a general implementation, which relates to matrix transformation, specifically, the inverse transformation of the matrix transformation. That is, when the current application is initiated, a matrix transformation is performed on the full-screen window for displaying the current application to obtain the non-full-screen window for displaying the current application. The non-full-screen window is displayed as a window region of the current interaction operation. The matrix transformation is a first matrix transformation. After the location coordinate parameters of the touch point is obtained in the region of the non-full-screen window, the location coordinate parameters of the touch point may be transformed into the location coordinate parameters of the touch point in a corresponding region of the full-screen window, which is a second matrix transformation, and actually is the matrix inverse transformation of the matrix transformation.

In Step 404 to Step 407 of the embodiment of the disclosure, interaction operations of the user with the M applications are detected, a window queue is established according to the sequence of the interaction operations. The window queue is updated in a timely manner. Therefore, one target window can be determined reasonably from multiple windows. It is because that: when the first event such as a user key-pressing operation or a touch operation is generally triggered, the first event is transmitted to the window using by the user currently. The window using by the user currently can be acquired by detecting the interaction operations of the user with the M applications. By detecting a touch point, interaction operations of the user with the M applications are detected, and a window queue is established according to the sequence of the interaction operations. The window queue is updated in a timely manner. In this way, it is accurately determined the window corresponding to the application for performing the interaction operation with the user at the last time, so as to optimize the detection. The first event is distributed to the target window and the application corresponding to the target window makes response to the first operation. Therefore, a target window may be determined reasonably from multiple windows, to distribute the key-pressing event to the target window. Hence, it is solved at least the problem that it is difficult to determine which windows the user distributes the key pressing operation to.

Herein, in a preferable embodiment of the disclosure, the method further includes the followings:

setting a window attribute of at least one window in the M windows to be a non-target window;

obtaining a control instruction for the interaction operation of the user with the M applications, where the control instruction characterizes a detection for the interaction operation to determine a target window in the M windows according to the window attribute; and

canceling a detection for a window corresponding to a current interaction operation during the detection for the interaction operation to determine the target window in the M windows, in the case where the window attribute of the window corresponding to the current interaction operation is detected to be the non-target window according to a predetermined parameter.

With the method according to the preferable embodiment of the disclosure, it is optimized for the process of detecting the interaction operation of the user with the M applications to obtain the target window for the event distribution. One or more certain windows are determined as a non-target window, which is not included in the detected target window, and thus enriching various implementations for the embodiment of the disclosure and improving the user experiment. For example, a certain window may be set by default by the user as the non-target window, and the user can top a certain window which is the non-target window in the system supporting a set-top function. Generally, the user needs to top the video window when watching a video, and set the video window as the non-target window since the video window is not the non-target window. Thus, the application of the video window does not accept the event distribution from the system or the user. In order to achieve the function, it is necessary to cancel the detection of a window corresponding to a current interaction operation and exclude the detected window corresponding to the current interaction operation from the process of the detection of the interaction operation to determine the target window in the M windows, once it is found that the window is the non-target window according the window attribute, during the detection of the interaction operation to determine the target window from the M windows.

The specific application scenes are taken as examples as follows.

In one scene, the user runs multiple applications on the electronic device, for example, three applications, such as a microblog, a QQ and a text editor, which may be displayed in the non-full-screen windows respectively. In order to description conveniently, the non-full-screen window for displaying the microblog is recorded as a window 1, the non-full-screen window for displaying the QQ is recorded as a window 2 and the non-full-screen window for displaying the text editor is recorded as a window 3. The user firstly interacts with the microblog, then with the QQ and finally with the text editor. At this time, the window 1, the window 2 and the window 3 are displayed simultaneously in the display region of the electronic device. Afterwards, the user may not use the electronic device for a period of time. Instead of a user touch operation, a user operation such as a user key-pressing operation is triggered when the users needs to use the electronic device again. At this time, since three windows are display simultaneously. It is difficult to determine which window the user key-pressing operation is distributed to, and thereby achieving the interaction operation of the user to the application. Therefore, it is necessary for the system to determine reasonably one target window from the window 1, the window 2 and the window 3, and distribute the user key-pressing operation to the target window. With regard to this problem, with the method according to the embodiment of the disclosure, the interaction operation between the user and the three applications is detected, the window corresponding to the application on which the interaction operation is performed by the user at the last time is determined as the target window. That is, the user runs the three windows by interaction with the applications (the microblog, the QQ and the text editor) in turn. The sequence of the interaction operation is firstly an interaction operation of the user with the microblog, then an interaction operation of the user with the QQ and finally an interaction operation of the user with the text editor. In the window queue established according to the sequence of the interaction operations, the sequence of window information is the window 1, the window 2 and the window 3. Therefore, the last window (the window 3) in the window queue is determined as the target window, and the user key-pressing operation is distributed to the window 3.

In another scene, not all of the windows are set as a possible target window to perform the detection of the interaction operation. A window queue is established according to the sequence of the interaction operations, and then the last window in the window queue is determined as the target window. For example, in the case of a video player, the user generally hopes to top the video player always in the region of the electronic device, so that the user can keep watching the video when other applications are run. At this time, the window for toping the video player may be not detected as a possible target window (such as a window X, with X being a natural number), and needs to be excluded from the target windows. Otherwise, if the window X is determined as the target window, the user key-pressing operation is distributed to the window X. Therefore, the user experiment for watching the video is disturbed. With regard to this problem, the window attribute of the video player may be set by default as a non-target window. For example, the window X is excluded from the detection for the target window when the video player is run in the window X. If it is detected that the window attribute of the video player corresponding to the current interaction operation is the non-target window, the detection of the window X corresponding to the video player is canceled and the user key-pressing operation is never distributed to the window X during the interaction operation detection to determine the target window in the multiple windows.

### Fifth Embodiment of a Method

An information processing method according to an embodiment of the disclosure is applied to an electronic device which includes a second obtaining unit. The electronic device may be a mobile terminal, such as a smart phone or a tablet computer.

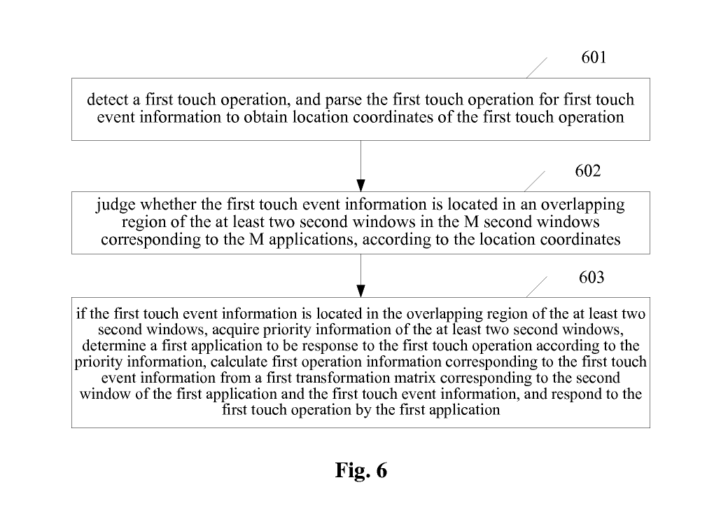

On the electronic device, multiple applications may be run and the multiple applications may be displayed in the display region of the second obtaining unit. In the case where M non-full-screen windows are opened, with M being larger than or equal to 2, as shown in FIG. 6, the method includes Step 601 to Step 603.

Step 601 is to detect a first touch operation, and parse the first touch operation for first touch event information to obtain location coordinates of the first touch operation.

Step 602 is to judge whether the first touch event information is located in an overlapping region of the at least two second windows in the M second windows corresponding to the M applications, according to the location coordinates.

Step 603 is to, if the first touch event information is located in the overlapping region of the at least two second windows, acquire priority information of the at least two second windows, determine a first application to be response to the first touch operation according to the priority information, calculate first operation information corresponding to the first touch event information from a first transformation matrix corresponding to the second window of the first application and the first touch event information, and respond to the first touch operation by the first application.

Preferably, the first touch event information includes the number of touch operations and location coordinates of the touch operations, and the location coordinates includes a starting coordinate and an ending coordinate of each touch operation.

Preferably, the step of judging whether the first touch event information is located in an overlapping region of the at least two second windows of the M second windows corresponding to the M applications further includes: checking whether a starting coordinate and an ending coordinate of the first touch operation are located in the overlapping region of the at least two second windows of the M second windows corresponding to the M applications, from frame cache data stored currently in a second obtaining unit, according to the starting coordinate and the ending coordinate of the first touch operation in the first touch event information.

Preferably, the priority information may include a scaling operation priority and/or times for the last operations of the at least two second windows.

Preferably, the first transformation matrix is an inverse matrix of a second transformation matrix corresponding to the second window of the application.

The second transformation matrix is adapted to transform the full-screen display window of the application into the second window, which is generated by: obtaining a default matrix when a first instruction is received; transforming the full-screen display window corresponding to the application by using the default matrix, and obtaining the display region of the non-full-screen window corresponding to the application.

The steps of transforming the display window corresponding to the application by using the default matrix and obtaining the display region of the non-full-screen window corresponding to the application includes: reading graphic cache data of the application; transforming the read graphic cache data by using the default matrix, generating the frame cache data corresponding to the second obtaining unit, from the graphic cache data; and displaying the non-full-screen window of the application in the second obtaining unit according to the frame cache data.

The graphic cache data includes coordinate information of pixel points and Red Green Blue (RGB) information of pixel points.

In view of the case where there may be an overlapping region of the second windows corresponding to two applications, as shown in FIG. 2. In the embodiment, a two-dimensional coordinate (xₒ, yₒ) for marking a pixel point in the graphic cache data of the second window corresponding to the application is expanded into a three-dimensional coordinate (xₒ, yₒ, zₒ), and the different second windows have different zₒ in the third dimensional coordinates. Therefore, the different second windows may be distinguished with different third dimensional coordinates.

The default matrix may be an identity matrix. The expanded three-dimensional coordinate (xₒ, yₒ, zₒ) in the graphic cache data is transformed to obtain the second window corresponding to the application. The graphic cache data corresponding to the second window includes the transformed (xₒ, yₒ, zₒ) and the RGB information of the corresponding pixel points.

Assuming that the full-screen display window is transformed into the second window by scaling down the full-screen display window by ½. The corresponding second transformation matrix is

$$( \begin{matrix}1 / 2 & 0 & 0 \\ 0 & 1 / 2 & 0 \\ 0 & 0 & 1 / 2\end{matrix} ) ,$$

and the three-dimensional coordinates (xₜ, yₜ, zₜ) of pixel points in the frame cache data corresponding to the second window are expressed as an equation (1):

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) \qquad ( 1 )$$

Assuming that the full-screen display window is transformed into the second window by scaling down the full-screen display window by ½ and then translating the full-screen display window by Δ x in the horizontal direction and Δ y in a vertical direction. The corresponding second transformation matrix is

$$( \begin{matrix}1 / 2 & 0 & Δ x \\ 0 & 1 / 2 & Δ y \\ 0 & 0 & 1 / 2\end{matrix} ) ,$$

and the three-dimensional coordinates (xₜ, yₜ, zₜ) of pixel points in the frame cache data corresponding to the second window are expressed as an equation (2):

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) \qquad ( 2 )$$

It can be seen that, according to the embodiment, the application corresponding to the touch operation may be determined and the application may respond to the touch operation, according to the current touch operation and the priority information of the second window, in the case where there is an overlapping region of two or more non-full-screen windows. Thus, a mass of operation may be avoided when multiple second windows are opened, and thereby the user experiment is improved.

### Seventh Embodiment of a Method

An information processing method according to an embodiment of the disclosure is applied to an electronic device, which has a second obtaining unit. The electronic device may be a mobile terminal, such as a smart phone or a tablet computer.

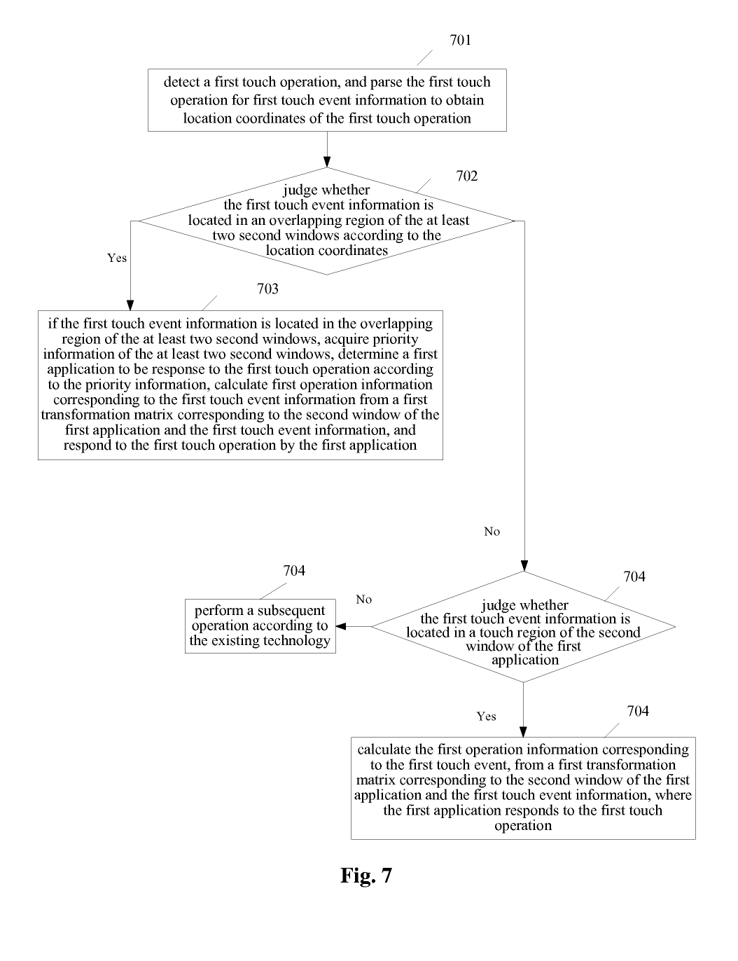

On the electronic device, multiple applications may be run and the multiple applications may be displayed in the display region of the second obtaining unit. In the case where M non-full-screen windows are opened, with M being larger than or equal to 2, as shown in FIG. 7, the method includes Step 701 to Step 704.

Step 701 is to detect a first touch operation, and parse the first touch operation for first touch event information to obtain location coordinates of the first touch operation.

Step 702 is to judge whether the first touch event information is located in an overlapping region of the at least two second windows in the M second windows corresponding to the M applications, according to the location coordinates.

Step 703 is to, if the first touch event information is located in the overlapping region of the at least two second windows, acquire priority information of the at least two second windows, determine a first application to be response to the first touch operation according to the priority information, calculate first operation information corresponding to the first touch event information from a first transformation matrix corresponding to the second window of the first application and the first touch event information, and respond to the first touch operation by the first application.

Step 704 is to judge whether the first touch event information is located in a touch region of the second window of the first application; if the first touch event information is located in a touch region of the second window of the first application, calculate the first operation information corresponding to the first touch event, from a first transformation matrix corresponding to the second window of the first application and the first touch event information, where the first application responds to the first touch operation; if the first touch event information is not located in a touch region of the second window of the first application, perform a subsequent operation according to the existing technology.

Preferably, the first touch event information includes the number of touch operations and location coordinates of the touch operations, and the location coordinates includes a starting coordinate and an ending coordinate of each touch operation.

Preferably, the step of judging whether the first touch event information is located in an overlapping region of the at least two second windows of the M second windows corresponding to the M applications further includes: checking whether a starting coordinate and an ending coordinate of the first touch operation are located in the overlapping region of the at least two second windows of the M second windows corresponding to the M applications, from frame cache data stored currently in the second obtaining unit, according to the starting coordinate and the ending coordinate of the first touch operation in the first touch event information.

Preferably, the priority information may include a scaling operation priority and/or times for the last operations of the at least two second windows.

Preferably, the first transformation matrix is an inverse matrix of a second transformation matrix corresponding to the second window of the application.

The second transformation matrix is adapted to transform the full-screen display window of the application into the second window, which is generated by: obtaining a default matrix when a first instruction is received; transforming the full-screen display window corresponding to the application by using the default matrix, and obtaining the display region of the non-full-screen window corresponding to the application.

The steps of transforming the display window corresponding to the application by using the default matrix and obtaining the display region of the non-full-screen window corresponding to the application includes: reading graphic cache data of the application; transforming the read graphic cache data by using the default matrix, generating the frame cache data corresponding to the second obtaining unit, from the graphic cache data; and displaying the non-full-screen window of the application in the second obtaining unit according to the frame cache data.

The graphic cache data includes coordinate information of pixel points and Red Green Blue (RGB) information of pixel points.

In view of the case where there may be an overlapping region of the second windows corresponding to two applications, as shown in FIG. 2. In the embodiment, an two-dimensional coordinate (xₒ, yₒ) for marking a pixel point in the graphic cache data of the second window corresponding to the application is expanded into a three-dimensional coordinate (xₒ, yₒ, zₒ), and the different second windows have different zₒ in the third dimensional coordinates. Therefore, the different second windows may be distinguished with different third dimensional coordinates.

The default matrix may be an identity matrix. The expanded three-dimensional coordinate (xₒ, yₒ, zₒ) in the graphic cache data is transformed to obtain the second window corresponding to the application. The graphic cache data corresponding to the second window includes the transformed (xₒ, yₒ, zₒ) and the RGB information of the corresponding pixel points.

Assuming that the full-screen display window is transformed into the second window by scaling down the full-screen display window by ½. The corresponding second transformation matrix is

$$( \begin{matrix}1 / 2 & 0 & 0 \\ 0 & 1 / 2 & 0 \\ 0 & 0 & 1 / 2\end{matrix} ) ,$$

and the three-dimensional coordinates (xₜ, yₜ, zₜ) of pixel points in the frame cache data corresponding to the second window are expressed as an equation (1):

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) . \qquad ( 1 )$$

Assuming that the full-screen display window is transformed into the second window by scaling down the full-screen display window by ½ and then translating the full-screen display window by Δ x in the horizontal direction and Δ y in a vertical direction. The corresponding second transformation matrix is

$$( \begin{matrix}1 / 2 & 0 & Δ x \\ 0 & 1 / 2 & Δ y \\ 0 & 0 & 1 / 2\end{matrix} ) ,$$

and the three-dimensional coordinates (xₜ, yₜ, zₜ) of pixel points in the frame cache data corresponding to the second window are expressed as an equation (2):

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) . \qquad ( 2 )$$

It can be seen that, according to the embodiment, the application corresponding to the touch operation may be determined and the application may respond to the touch operation, according to the current touch operation and the priority information of the second window, in the case where there is the overlapping region of two or more non-full-screen windows. Thus, a mass of operation may be avoided when multiple second windows are opened, and thereby the user experiment is improved.

### Eighth Embodiment of a Method

An information processing method according to an embodiment of the disclosure is applied to an electronic device, which has a second obtaining unit. The electronic device may be a mobile terminal, such as a smart phone or a tablet computer.

On the electronic device, multiple applications may be run and the multiple applications may be displayed in the display region of the second obtaining unit. In the case where M second windows are opened, with M being larger than or equal to 2, as shown in FIG. 7, the method includes Step 701 to Step 704.

Step 701 is to detect a first touch operation, and parse the first touch operation for first touch event information to obtain location coordinates of the first touch operation.

Step 702 is to judge whether the first touch event information is located in an overlapping region of the at least two second windows in the M second windows corresponding to the M applications, according to the location coordinates.

Step 703 is to, if the first touch event information is located in the overlapping region of the at least two second windows, acquire priority information of the at least two second windows, determine a first application to be response to the first touch operation according to the priority information, calculate first operation information corresponding to the first touch event information from a first transformation matrix corresponding to the second window of the first application and the first touch event information, and respond to the first touch operation by the first application.

Step 704 is to judge whether the first touch event information is located in a touch region of the second window of the first application; if the first touch event information is located in a touch region of the second window of the first application, calculate the first operation information corresponding to the first touch event, from the first transformation matrix corresponding to the second window of the first application and the first touch event information, where the first application responds to the first touch operation; if the first touch event information is not located in a touch region of the second window of the first application, perform a subsequent operation according to the existing technology.

Preferably, the first touch event information includes the number of touch operations and location coordinates of the touch operations, and the location coordinates includes a starting coordinate and an ending coordinate of each touch operation.

Preferably, the step of judging whether the first touch event information is located in an overlapping region of the at least two second windows of the M second windows corresponding to the M applications further includes checking whether a starting coordinate and an ending coordinate of the first touch operation are located in the overlapping region of the at least two second windows of the M second windows corresponding to the M applications, from frame cache data stored currently in the second obtaining unit, according to the starting coordinate and the ending coordinate of the first touch operation in the first touch event information.

Preferably, the priority information may include a scaling operation priority and/or times for the last operations of the at least two second windows.

Preferably, the first transformation matrix is an inverse matrix of a second transformation matrix corresponding to the second window of the application.

The second transformation matrix is adapted to transform the full-screen display window of the application into the second window, which is generated by: obtaining a default matrix when a first instruction is received; transforming the full-screen display window corresponding to the application by using the default matrix, and obtaining the display region of the second window corresponding to the application.

The steps of transforming the display window corresponding to the application by using the default matrix and obtaining the display region of the second window corresponding to the application includes: reading graphic cache data of the application; transforming the read graphic cache data by using the default matrix, generating the frame cache data corresponding to the second obtaining unit, from the graphic cache data; and displaying the second window of the application in the second obtaining unit according to the frame cache data.

The graphic cache data includes coordinate information of pixel points and Red Green Blue (RGB) information of pixel points.

In view of the case where there may be an overlapping region of the second windows corresponding to two applications, as shown in FIG. 2. In the embodiment, an two-dimensional coordinate (xₒ, yₒ) for marking a pixel point in the graphic cache data of the second window corresponding to the application is expanded into a three-dimensional coordinate (xₒ, yₒ, zₒ), and the different second windows have different zₒ in the third dimensional coordinates. Therefore, the different second windows may be distinguished with different third dimensional coordinates.

The default matrix may be an identity matrix. The expanded three-dimensional coordinate (xₒ, yₒ, zₒ) in the graphic cache data is transformed to obtain the second window corresponding to the application. The graphic cache data corresponding to the second window includes the transformed (xₒ, yₒ, zₒ) and the RGB information of the corresponding pixel points.

Assuming that the full-screen display window is transformed into the second window by scaling down the full-screen display window by ½. The corresponding second transformation matrix is

$$( \begin{matrix}1 / 2 & 0 & 0 \\ 0 & 1 / 2 & 0 \\ 0 & 0 & 1 / 2\end{matrix} ) ,$$

and the three-dimensional coordinates (xₜ, yₜ, zₜ) of pixel points in the frame cache data corresponding to the second window are expressed as an equation (1):

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) \qquad ( 1 )$$

Assuming that the full-screen display window is transformed into the second window by scaling down the full-screen display window by ½ and then translating the full-screen display window by Δ x in the horizontal direction and Δ y in a vertical direction, the corresponding second transformation matrix is

$$( \begin{matrix}1 / 2 & 0 & Δ x \\ 0 & 1 / 2 & Δ y \\ 0 & 0 & 1 / 2\end{matrix} ) ,$$

and the three-dimensional coordinates (xₜ, yₜ, zₜ) of pixel points in the frame cache data corresponding to the second window are expressed as an equation (2),

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) \qquad ( 2 )$$

It can be seen that, according to the embodiment, the application corresponding to the touch operation may be determined and the application may respond to the touch operation, according to the current touch operation and the priority information of the second window, in the case where there is the overlapping region of two or more non-full-screen windows. Thus, a mass of operation may be avoided when multiple second windows are opened, and thereby the user experiment is improved.

Preferably, the step of acquiring priority information of at least two second windows and determining a first application according to the priority information, includes:

Judging whether the first touch event is a transformation operation for the non-full-screen window; in the case where the first touch event is the transformation operation for the non-full-screen window, obtaining the priorities of the transformation operations for the non-full-screen windows from the priority information of the at least two non-full-screen windows, and determining the application with a higher priority of the transformation operation for the non-full-screen window as a first application; and

in the case where the first touch event is not the transformation operation for the non-full-screen window, obtaining the operation priorities from the priority information for the at least two non-full-screen windows, and determining the application with a higher operation priority as the first application.

In this way, the operation object of the first touch event may be selected according to the priority information corresponding to the second window of the application and the current first touch event. Thereby, the second window to be operated may be determined simply according to a gesture, and the user experience may be improved.

### Ninth Embodiment of a Method

An information processing method according to an embodiment of the disclosure is applied to an electronic device, which has a second obtaining unit. The electronic device may be a mobile terminal, such as a smart phone or a tablet computer.

On the electronic device, multiple applications may be run and the multiple applications may be displayed in the display region of the second obtaining unit. In the case where M second windows are opened, with M being larger than or equal to 2, as shown in FIG. 7, the method includes Step 701 to Step 704.

Step 701 is to detect a first touch operation, and parse the first touch operation for first touch event information to obtain location coordinates of the first touch operation.

Step 702 is to judge whether the first touch event information is located in an overlapping region of the at least two second windows in the M second windows corresponding to the M applications, according to the location coordinates.

Step 703 is to, if the first touch event information is located in the overlapping region of the at least two second windows, acquire priority information of the at least two second windows, determine a first application to be response to the first touch operation according to the priority information, calculate first operation information corresponding to the first touch event information from a first transformation matrix corresponding to the second window of the first application and the first touch event information, and respond to the first touch operation by the first application.

Step 704 is to judge whether the first touch event information is located in a touch region of the second window of the first application; if the first touch event information is located in a touch region of the second window of the first application, calculate the first operation information corresponding to the first touch event, from the first transformation matrix corresponding to the second window of the first application and the first touch event information, where the first application responds to the first touch operation; if the first touch event information is not located in a touch region of the second window of the first application, perform a subsequent operation according to the existing technology.

Preferably, the first touch event information includes the number of touch operations and location coordinates of the touch operations, and the location coordinates includes a starting coordinate and an ending coordinate of each touch operation.

Preferably, the step of judging whether the first touch event information is located in an overlapping region of the at least two second windows of the M second windows corresponding to the M applications further includes: checking whether a starting coordinate and an ending coordinate of the first touch operation are located in the overlapping region of the at least two second windows of the M second windows corresponding to the M applications, from frame cache data stored currently in the second obtaining unit, according to the starting coordinate and the ending coordinate of the first touch operation in the first touch event information.

Preferably, the priority information may include a scaling operation priority and/or times for the last operations of the at least two second windows.

Preferably, the first transformation matrix is an inverse matrix of a second transformation matrix corresponding to the second window of the application.

The second transformation matrix is adapted to transform the full-screen display window of the application into the second window, which is generated by: obtaining a default matrix when a first instruction is received; transforming the full-screen display window corresponding to the application by using the default matrix, and obtaining the display region of the second window corresponding to the application.

The steps of transforming the display window corresponding to the application by using the default matrix and obtaining the display region of the second window corresponding to the application includes: reading graphic cache data of the application; transforming the read graphic cache data by using the default matrix, generating the frame cache data corresponding to the second obtaining unit, from the graphic cache data; and displaying the second window of the application in the second obtaining unit according to the frame cache data.

The graphic cache data includes coordinate information of pixel points and Red Green Blue (RGB) information of pixel points.

In view of the case where there may be an overlapping region of the second windows corresponding to two applications, as shown in FIG. 2. In the embodiment, an two-dimensional coordinate (xₒ, yₒ) for marking a pixel point in the graphic cache data of the second window corresponding to the application is expanded into a three-dimensional coordinate (xₒ, yₒ, zₒ), and the different second windows have different zₒ in the third dimensional coordinates. Therefore, the different second windows may be distinguished with different third dimensional coordinates.

The default matrix may be an identity matrix. The expanded three-dimensional coordinate (xₒ, yₒ, zₒ) in the graphic cache data is transformed to obtain the second window corresponding to the application. The graphic cache data corresponding to the second window includes the transformed (xₒ, yₒ, zₒ) and the RGB information of the corresponding pixel points.

Assuming that the full-screen display window is transformed into the second window by scaling down the full-screen display window by ½. The corresponding second transformation matrix is

$$( \begin{matrix}1 / 2 & 0 & 0 \\ 0 & 1 / 2 & 0 \\ 0 & 0 & 1 / 2\end{matrix} ) ,$$

and the three-dimensional coordinates (xₜ, yₜ, zₜ) of pixel points in the frame cache data corresponding to the second window are expressed as an equation (1):

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) . \qquad ( 1 )$$

Assuming that the full-screen display window is transformed into the second window by scaling down the full-screen display window by ½ and then translating the full-screen display window by Δ x in the horizontal direction and Δ y in a vertical direction, the corresponding second transformation matrix is

$$( \begin{matrix}1 / 2 & 0 & Δ x \\ 0 & 1 / 2 & Δ y \\ 0 & 0 & 1 / 2\end{matrix} ) ,$$

and the three-dimensional coordinates (xₜ, yₜ, zₜ) of pixel points in the frame cache data corresponding to the second window are expressed as an equation (2),

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) . \qquad ( 2 )$$

It can be seen that, according to the embodiment, the application corresponding to the touch operation may be determined and the application may respond to the touch operation, according to the current touch operation and the priority information of the second window, in the case where there is the overlapping region of two or more non-full-screen window. Thus, a mass of operation may be avoided when multiple second windows are opened, and thereby the user experiment is improved.

Preferably, the step of calculating the first operation information corresponding to the first touch event, from a first transformation matrix corresponding to the second window of the first application and the first touch event information includes:

transforming the starting coordinate and the ending coordinate of the first touch event information, by using the first transformation matrix corresponding to the second window of the first application; and

determining the transformed starting coordinate and the transformed ending coordinate as the first operation information corresponding to the first touch operation.

Preferably, the step of acquiring priority information of at least two second windows and determining a first application according to the priority information, includes:

judging whether the first touch event is a transformation operation for the non-full-screen window; in the case where the first touch event is the transformation operation for the non-full-screen window, obtaining the priorities of the transformation operations for the non-full-screen windows from the priority information of the at least two non-full-screen windows, and determining the application with a higher priority of the transformation operation for the non-full-screen window as a first application; and

in the case where the first touch event is not the transformation operation for the non-full-screen window, obtaining the operation priorities from the priority information for the at least two non-full-screen windows, and determining the application with a higher operation priority as the first application.

In this way, the operation object of the first touch event may be selected according to the priority information corresponding to the second window of the application and the current first touch event. Thereby, the second window to be operated may be determined simply according to a gesture, and the user experience may be improved.

### Tenth Embodiment of a Method

An information processing method according to an embodiment of the disclosure is applied to an electronic device, which has a second obtaining unit. The electronic device may be a mobile terminal, such as a smart phone or a tablet computer.

On the electronic device, multiple applications may be run and the multiple applications may be displayed in the display region of the second obtaining unit. In the case where M second windows are opened, with M being larger than or equal to 2, as shown in FIG. 7, the method includes Step 701 to Step 704.

Step 701 is to detect a first touch operation, and parse the first touch operation for first touch event information to obtain location coordinates of the first touch operation.

Step 702 is to judge whether the first touch event information is located in an overlapping region of the at least two second windows in the M second windows corresponding to the M applications, according to the location coordinates.

Step 703 is to, if the first touch event information is located in the overlapping region of the at least two second windows, acquire priority information of the at least two second windows, determine a first application to be response to the first touch operation according to the priority information, calculate first operation information corresponding to the first touch event information from a first transformation matrix corresponding to the second window of the first application and the first touch event information, and respond to the first touch operation by the first application.

Step 704 is to judge whether the first touch event information is located in a touch region of the second window of the first application; if the first touch event information is located in a touch region of the second window of the first application, calculate the first operation information corresponding to the first touch event, from the first transformation matrix corresponding to the second window of the first application and the first touch event information, where the first application responds to the first touch operation; if the first touch event information is not located in a touch region of the second window of the first application, perform a subsequent operation according to the existing technology.

Preferably, the first touch event information includes the number of touch operations and location coordinates of the touch operations, and the location coordinates includes a starting coordinate and an ending coordinate of each touch operation.

Preferably, the step of judging whether the first touch event information is located in an overlapping region of the at least two second windows of the M second windows corresponding to the M applications further includes: checking whether a starting coordinate and an ending coordinate of the first touch operation are located in the overlapping region of the at least two second windows of the M second windows corresponding to the M applications, from frame cache data stored currently in the second obtaining unit, according to the starting coordinate and the ending coordinate of the first touch operation in the first touch event information.

Preferably, the priority information may include a scaling operation priority and/or times for the last operations of the at least two second windows.

Preferably, the first transformation matrix is an inverse matrix of a second transformation matrix corresponding to the second window of the application. For example, in the case where the second transformation matrix is a default matrix preset for the system, the method for calculating the first transformation matrix includes: calculating an inverse of the second transformation matrix, i.e.:

$${( \begin{matrix}1 & 0 & 0 \\ 0 & 1 & 0 \\ 0 & 0 & 1\end{matrix} )}^{- 1} .$$

The second transformation matrix is adapted to transform the full-screen display window of the application into the second window, which is generated by: obtaining a default matrix when a first instruction is received; transforming the full-screen display window corresponding to the application by using the default matrix, and obtaining the display region of the second window according to the application.

The steps of transforming the display window corresponding to the application by using the default matrix and obtaining the display region of the second window corresponding to the application includes: reading graphic cache data of the application; transforming the read graphic cache data by using the default matrix, generating the frame cache data corresponding to the second obtaining unit, from the graphic cache data; and displaying the second window of the application in the second obtaining unit according to the frame cache data.

The graphic cache data includes coordinate information of pixel points and Red Green Blue (RGB) information of pixel points.

In view of the case where there may be an overlapping region of the second windows corresponding to two applications, as shown in FIG. 2. In the embodiment, an two-dimensional coordinate (xₒ, yₒ) for marking a pixel point in the graphic cache data of the second window corresponding to the application is expanded into a three-dimensional coordinate (xₒ, yₒ, zₒ), and the different second windows have different zₒ in the third dimensional coordinates. Therefore, the different second windows may be distinguished with different third dimensional coordinates.

The default matrix may be an identity matrix. The expanded three-dimensional coordinate (xₒ, yₒ, zₒ) in the graphic cache data is transformed to obtain the second window corresponding to the application. The graphic cache data corresponding to the second window includes the transformed (xₜ, yₜ, zₜ) and the RGB information of the corresponding pixel points.

Assuming that the full-screen display window is transformed into the second window by scaling down the full-screen display window by ½. The corresponding second transformation matrix is

$$( \begin{matrix}1 / 2 & 0 & 0 \\ 0 & 1 / 2 & 0 \\ 0 & 0 & 1 / 2\end{matrix} ) ,$$

and the three-dimensional coordinates (xₜ, yₜ, zₜ) of pixel points in the frame cache data corresponding to the second window are expressed as an equation (1):

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) . \qquad ( 1 )$$

Assuming the full-screen display window is transformed into the second window by scaling down the full-screen display window by ½ and then translating the full-screen display window by Δ x in the horizontal direction and Δ y in a vertical direction, the corresponding second transformation matrix is

$$( \begin{matrix}1 / 2 & 0 & Δ x \\ 0 & 1 / 2 & Δ y \\ 0 & 0 & 1 / 2\end{matrix} ) ,$$

and the three-dimensional coordinates (xₜ, yₜ, zₜ) of pixel points in the frame cache data corresponding to the second window are expressed as an equation (2),

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) . \qquad ( 2 )$$

It can be seen that, according to the embodiment, the application corresponding to the touch operation may be determined and the application may respond to the touch operation, according to the current touch operation and the priority information of the second window, in the case where there is the overlapping region of two or more second window. Thus, a mass of operation may be avoided when multiple second windows are opened, and thereby the user experiment is improved.

Preferably, the step of calculating the first operation information corresponding to the first touch event, from a first transformation matrix corresponding to the second window of the first application and the first touch event information includes:

transforming the starting coordinate and the ending coordinate of the first touch event information, by using the first transformation matrix corresponding to the second window of the first application; and

determining the transformed starting coordinate and the transformed ending coordinate as the first operation information corresponding to the first touch operation.

Preferably, the first application responding to the first touch operation includes:

determining operation type of the first touch operation, according to the transformed starting coordinate and the transformed ending coordinate in the first operation information; in the case where the operation type of the first touch operation is a clicking operation, determining that the first operation information is event coordinates for the selected first application, and generating response information for the event coordinates; and in the case where the operation type of the first operation information is a sliding operation, making a response by the first application according to the first operation information.

The determining operation type of the first touch operation according to the transformed starting coordinate and the transformed ending coordinate in the first operation information may include: determining the operation type is the clicking operation, in the case where the starting coordinate and the ending coordinate of the operation are the same; determining the operation type is a sliding operation, in the case where the starting coordinate and the ending coordinate of the operation are different and the distance between the starting coordinate and the ending coordinate is larger than a preset threshold; and determining the operation type is a scaling operation, in the case where there are multiple touch operations and the distance between the starting coordinate and ending coordinate of each of the touch operations is larger than the preset threshold.

Preferably, the step of acquiring priority information of at least two second windows and determining a first application according to the priority information, includes:

judging whether the first touch event is a transformation operation for the second window; in the case where the first touch event is the transformation operation for the second window, obtaining the priorities for the transformation operations for the second windows from the priority information of the at least two second windows, and determining the application with a higher priority of the transformation operation for the second window as a first application; and

in the case where the first touch event is not the transformation operation for the second window, obtaining the operation priorities from the priority information for the at least two second windows, and determining the application with a higher priority as the first application.

In this way, the operation object of the first touch event may be selected according to the priority information corresponding to the second window of the application and the current first touch event. Thereby, the second window to be operated may be determined simply according to a gesture, and the user experience may be improved.

It should be noted herein that the following description for the electronic device is similar as that for the above-mentioned method and the advantageous effect thereof is the same, which is not repeated herein. The technical details not disclosed in the embodiments of the electronic device according to the disclosure may be referred to the description for the embodiments of the method according to the disclosure.

### First Embodiment of an Electronic Device

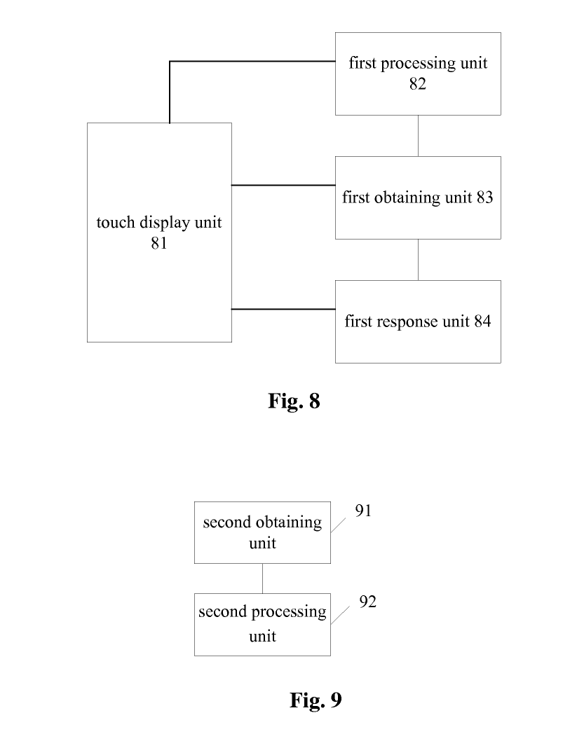

As shown in FIG. 8, the electronic device according the embodiment of the disclosure includes a touch display unit 81. The touch display unit 81 includes a display region, and M windows corresponding to M applications are displayed at the display region, where M is a positive integer. The M windows includes at least one non-full-screen window among the M windows. The electronic device further includes: a first processing unit 82, a first obtaining unit 83, and a first response unit 84.

The first processing unit 82 is adapted to initiate an application of the M applications in a non-full-screen window, obtain a first parameter, and transform a first window of the application into a second window of the application by using the first parameter, where the first window is a full-screen window, and a display region of the second window is smaller than a display region of the full-screen window of the application; and the touch display unit 81 is adapted to presenting the second window of the application in the display region.

The first obtaining unit 83 is adapted to detect a first operation of a user to obtain a first event.

The first response unit 84 is adapted to in response to the first event, determine a target window from the M windows according to a preset rule, and distribute the first event to the target window, where an application corresponding to the target window responds to the first operation.

It should be noted that the first parameter in the embodiment is a transformation parameter for a window transformation, which may be at least one of:

a parameter value, a matrix, a parameter group and a parameter set.

When the first parameter is the matrix, the way for transforming the first window into the second window by using the matrix transformation described in detail in the above embodiment of the method may be related, which is not repeated herein.

### Second Embodiment of an Electronic Device

As shown in FIG. 8, the electronic device according the embodiment of the disclosure includes a touch display unit 81. The touch display unit 81 includes a display region, and M windows corresponding to M applications are displayed at the display region, where M is a positive integer. The M windows includes at least one non-full-screen window among the M windows. The electronic device further includes: a first processing unit 82, a first obtaining unit 83, and a first response unit 84.

The first processing unit 82 is adapted to initiate an application of the M applications in a non-full-screen window, obtain a first parameter, and transform a first window of the application into a second window of the application by using the first parameter, where the first window is a full-screen window, and a display region of the second window is smaller than a display region of the full-screen window of the application; and the touch display unit 81 is adapted to present the second window of the application in the display region.

The first obtaining unit 83 is adapted to detect a first operation of a user to obtain a first event.

The first response unit 84 is adapted to detect interaction operations of the user with the M applications, and determine, as the target window, a window corresponding to an application on which the user performs the last interaction operation, and distribute the first event to the target window, where an application corresponding to the target window responds to the first operation.

It should be noted that the first parameter in the embodiment is a transformation parameter for a window transformation, which may be at least one of:

a parameter value, a matrix, a parameter group and a parameter set.

When the first parameter is the matrix, the way for transforming the first window into the second window by using the matrix transformation described in detail in the above embodiment of the method may be related, which is not repeated herein.

### Third Embodiment of an Electronic Device

As shown in FIG. 8, the electronic device according the embodiment of the disclosure includes a touch display unit 81. The touch display unit 81 includes a display region, and M windows corresponding to M applications are displayed at the display region, where M is a positive integer. The M windows includes at least one non-full-screen window among the M windows. The electronic device further includes: a first processing unit 82, a first obtaining unit 83, and a first response unit 84.

The first processing unit 82 is adapted to initiate an application of the M applications in a non-full-screen window, obtain a first parameter, and transform a first window of the application into a second window of the application by using the first parameter, where the first window is a full-screen window, and a display region of the second window is smaller than a display region of the full-screen window of the application; and the touch display unit 81 is adapted to present the second window of the application in the display region.

The first obtaining unit 83 is adapted to detect a first operation of a user to obtain a first event.

The first response unit 84 is adapted to in response to the first event, detect interaction operations of the user with the M applications, establish a window queue according to a sequence of the interaction operations, update the window queue in a timely manner, and determine a last window in the window queue as the target window, distribute the first event to the target window, where the application corresponding to the target window responds to the first operation.

It should be noted that the first parameter in the embodiment is a transformation parameter for a window transformation, which may be at least one of:

a parameter value, a matrix, a parameter group and a parameter set.

When the first parameter is the matrix, the way for transforming the first window into the second window by using the matrix transformation described in detail in the above embodiment of the method may be related, which is not repeated herein.

### Fourth Embodiment of an Electronic Device

As shown in FIG. 8, the electronic device according the embodiment of the disclosure includes a touch display unit 81. The touch display unit 81 includes a display region, and M windows corresponding to M applications are displayed at the display region, where M is a positive integer. The M windows includes at least one non-full-screen window among the M windows. The electronic device further includes: a first processing unit 82, a first obtaining unit 83, and a first response unit 84.

The first processing unit 82 is adapted to initiate an application of the M applications in a non-full-screen window, obtain a first parameter, and transform a first window of the application into a second window of the application by using the first parameter, where the first window is a full-screen window, and a display region of the second window is smaller than a display region of the full-screen window of the application; and the touch display unit 81 is adapted to present the second window of the application in the display region.

The first obtaining unit 83 is adapted to detect a first operation of a user to obtain a first event.

The first response unit 84 is adapted to in response to the first event, detect interaction operations of the user with the M applications, according to a location of a touch point detected in the region of the window of the application during the interaction operation of the user with the application; add into the window queue a window on which the interaction operation is performed currently, in the case where the touch point is detected at the first time in the region of the window on which the interaction operation is performed currently; not update the window queue, in the case where the position of the touch point is detected to remain in the region of the window on which the interaction operation is performed currently; and obtain the location of the touch point and add a window with the location of the touch point into the window queue to update the window queue, in the case where the position of the touch point is detected to be outside the region of the window on which the interaction operation is performed currently; after the window queue is updated, determine a last window in the window queue as the target window; distribute the first event to the target window, where the application corresponding to the target window responds to the first operation.

It should be noted that, the first parameter in the embodiment is a transformation parameter for a window transformation, which may be at least one of:

a parameter value, a matrix, a parameter group and a parameter set.

In the case where the first parameter is the matrix, the way for transforming the first window into the second window by using the matrix transformation described in detail in the above embodiment of the method may be related, which is not repeated herein.

Herein, according to a preferable embodiment of the disclosure, the electronic device further includes: a setting unit adapted to set the window attribute of at least one window in the M windows to be a non-target window; a control instruction obtaining unit adapted to obtain a control instruction for the interaction operation of the user with the M applications, where the control instruction is used for characterizes a detection for the interaction operation to determine a target window in the M windows according to the window attribute; and a second response unit adapted to cancel a detection of a window corresponding to a current interaction operation during the detection for the interaction operation to determine a target window in the M windows, in the case where the window attribute of the window corresponding to the current interaction operation is detected to be the non-target window according to a predetermined parameter.

### Fifth Embodiment of an Electronic Device

The embodiment of the disclosure provides an electronic device. As shown in FIG. 9, the electronic device includes a second obtaining unit 91 and a second processing unit 92.

The second obtaining unit 91 is adapted to display a second window in a display region; parse a first touch operation for first touch event information, when the first touch operation is detected in the case where M applications are run in a non-full-screen mode and the second window is open in the non-full-screen mode; obtain location coordinates of the first touch operation; and transmit the location coordinates to the second processing unit 92.

The second processing unit 92 is adapted to judge whether the first touch event information is located in an overlapping region of the at least two second windows in the M second windows corresponding to the M application, according to the location coordinates; if the first touch event information is located in the overlapping region of the at least two second windows, acquire priority information corresponding to the at least two second windows, determine a first application to be response to the first touch operation according to the priority information, calculate first operation information corresponding to the first touch event from a first transformation matrix corresponding to the second window of the first application and the first touch event information, and respond to the first touch event by the first application.

Preferably, the first touch event information includes the number of touch operations and the location coordinates of the touch operations, and the location coordinates includes a starting coordinate and an ending coordinate of each touch operation.

Preferably, the second processing unit 92 is adapted to check whether a starting coordinate and an ending coordinate of the first touch operation are located in the overlapping region of the at least two second windows of the M second windows corresponding to the M applications, from frame cache data stored in the second obtaining unit 91, according to the starting coordinate and the ending coordinate of the first touch operation in the first touch event information.

Preferably, the priority information may include a scaling operation priority and/or times for the last operations of the at least two second windows.

Preferably, the first transformation matrix is an inverse matrix of a second transformation matrix corresponding to the second window of the application.

The second processing unit 92 is adapted to generate a second window. The method for generated the second window includes: obtaining a default matrix when a first instruction is received; transforming the full-screen display window corresponding to the application by using the default matrix, and obtaining the display region of the second window corresponding to the application.

The second processing unit 92 is adapted to read graphic cache data of the application; transform the read graphic cache data by using the default matrix, generate the frame cache data corresponding to the second obtaining unit from the graphic cache data; and display the second window of the application in the second obtaining unit according to the frame cache data.

The graphic cache data includes coordinate information of pixel points and Red Green Blue (RGB) information of pixel points.

In view of the case where there may be an overlapping region of the second windows corresponding to two applications, as shown in FIG. 2. In the embodiment, an two-dimensional coordinate (xₒ, yₒ) for marking a pixel point in the graphic cache data of the second window corresponding to the application is expanded into a three-dimensional coordinate (xₒ, yₒ, zₒ), and the different second windows have different zₒ in the third dimensional coordinates. Therefore, the different second windows may be distinguished with different third dimensional coordinates.

The default matrix may be an identity matrix. The expanded three-dimensional coordinate (xₒ, yₒ, zₒ) in the graphic cache data is transformed to obtain the second window corresponding to the application. The graphic cache data corresponding to the second window includes the transformed (xₒ, yₒ, zₒ) and the RGB information of the corresponding pixel points.

Assuming that the full-screen display window is transformed into the second window by scaling down the full-screen display window by ½. The corresponding second transformation matrix is

$$( \begin{matrix}1 / 2 & 0 & 0 \\ 0 & 1 / 2 & 0 \\ 0 & 0 & 1 / 2\end{matrix} ) ,$$

and the three-dimensional coordinates (xₜ, yₜ, zₜ) of pixel points in the frame cache data corresponding to the second window are expressed as an equation (1):

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) . \qquad ( 1 )$$

Assuming that the full-screen display window is transformed into the second window by scaling down the full-screen display window by ½ and then translating the full-screen display window by Δ x in the horizontal direction and Δ y in a vertical direction. The corresponding second transformation matrix is

$$( \begin{matrix}1 / 2 & 0 & Δ x \\ 0 & 1 / 2 & Δ y \\ 0 & 0 & 1 / 2\end{matrix} ) ,$$

and the three-dimensional coordinates (xₜ, yₜ, zₜ) of pixel points in the frame cache data corresponding to the second window are expressed as an equation (2):

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) . \qquad ( 2 )$$

It can be seen that, according to the embodiment, the application corresponding to the touch operation may be determined and the application may respond to the touch operation, according to the current touch operation and the priority information of the second window, in the case where there is the overlapping region of two or more second windows. Thus, a mass of operation may be avoided when multiple second windows are opened, and thereby the user experiment is improved.

### Sixth Embodiment of an Electronic Device

The embodiment of the disclosure provides an electronic device. As shown in FIG. 9, the electronic device includes a second obtaining unit 91 and a second processing unit 92.

The second obtaining unit 91 is adapted to display a second window in a display region; parse a first touch operation for first touch event information, when the first touch operation is detected in the case where M applications are run in a non-full-screen mode and the second window is open in the non-full-screen mode; obtain location coordinates of the first touch operation; and transmit the location coordinates to the second processing unit 92.

The second processing unit 92 is adapted to judge whether the first touch event information is located in an overlapping region of the at least two second windows in the M second windows corresponding to the M application, according to the location coordinates; if the first touch event information is located in the overlapping region of the at least two second windows, acquire priority information corresponding to the at least two second windows, determine a first application to be response to the first touch operation according to the priority information, calculate first operation information corresponding to the first touch event from a first transformation matrix corresponding to the second window of the first application and the first touch event information, and respond to the first touch event by the first application.

Preferably, the first touch event information includes the number of touch operations and the location coordinates of the touch operations, and the location coordinates includes a starting coordinate and an ending coordinate of each touch operation.

Preferably, the second processing unit 92 is adapted to check whether a starting coordinate and an ending coordinate of the first touch operation are located in the overlapping region of the at least two second windows of the M second windows corresponding to the M applications, from frame cache data stored in the second obtaining unit 91, according to the starting coordinate and the ending coordinate of the first touch operation in the first touch event information.

Preferably, the priority information may include a scaling operation priority and/or times for the last operations of the at least two second windows.

Preferably, the second processing unit 92 is adapted to judge whether the first touch event is located in the overlapping region of the at least two second windows of the M second windows corresponding to the M application; if the first touch event is not located in the overlapping region of the at least two second windows, judge whether the first touch event is located the touch region of the second window of the first application; and if the first touch event is located in the overlapping region of the at least two second windows, calculate first operation information corresponding to the first touch operation by using the first transformation matrix of the first application and the first touch event information, and respond to the first touch event by the first application based on the first operation information; otherwise, perform the subsequent operation according to the existing technology.

Preferably, the first touch event information includes the number of touch operations and the location coordinates of the touch operations, and the location coordinates includes a starting coordinate and an ending coordinate of each touch operation.

Preferably, the second processing unit 92 is adapted to check whether a starting coordinate and an ending coordinate of the first touch operation are located in the overlapping region of the at least two second windows of the M second windows corresponding to the M applications, from frame cache data stored in the second obtaining unit 91, according to the starting coordinate and the ending coordinate of the first touch operation in the first touch event information.

Preferably, the priority information may include a scaling operation priority and/or times for the last operations of the at least two second windows.

Preferably, the first transformation matrix is an inverse matrix of a second transformation matrix corresponding to the second window of the application. For example, in the case where the second transformation matrix is a default matrix preset for the system, the method for calculating the first transformation matrix includes: calculating an inverse of the second transformation matrix, i.e.:

$${( \begin{matrix}1 & 0 & 0 \\ 0 & 1 & 0 \\ 0 & 0 & 1\end{matrix} )}^{- 1} .$$

The second processing unit 92 is further adapted to generate a second window. The method for generated the second window includes: obtaining a default matrix when a first instruction is received; transforming the full-screen display window corresponding to the application by using the default matrix, and obtaining the display region of the second window corresponding to the application.

The second processing unit 92 is further adapted to read graphic cache data of the application; transform the read graphic cache data by using the default matrix, generate the frame cache data corresponding to the second obtaining unit from the graphic cache data; and display the second window of the application in the second obtaining unit according to the frame cache data.

The graphic cache data includes coordinate information of pixel points and Red Green Blue (RGB) information of pixel points.

In view of the case where there may be an overlapping region of the second windows corresponding to two applications, as shown in FIG. 2. In the embodiment, an two-dimensional coordinate (xₒ, yₒ) for marking a pixel point in the graphic cache data of the second window corresponding to the application is expanded into a three-dimensional coordinate (xₒ, yₒ, zₒ), and the different second windows have different zₒ in the third dimensional coordinates. Therefore, the different second windows may be distinguished with different third dimensional coordinates.

The default matrix may be an identity matrix. The expanded three-dimensional coordinate (xₒ, yₒ, zₒ) in the graphic cache data is transformed to obtain the second window corresponding to the application. The graphic cache data corresponding to the second window includes the transformed (xₒ, yₒ, zₒ) and the RGB information of the corresponding pixel points.

Assuming that the full-screen display window is transformed into the second window by scaling down the full-screen display window by ½. The corresponding second transformation matrix is

$$( \begin{matrix}1 / 2 & 0 & 0 \\ 0 & 1 / 2 & 0 \\ 0 & 0 & 1 / 2\end{matrix} ) ,$$

and the three-dimensional coordinates (xₜ, yₜ, zₜ) of pixel points in the frame cache data corresponding to the second window are expressed as an equation (1):

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) . \qquad ( 1 )$$

Assuming that the full-screen display window is transformed into the second window by scaling down the full-screen display window by ½ and then translating the full-screen display window by Δ x in the horizontal direction and Δ y in a vertical direction. The corresponding second transformation matrix is

$$( \begin{matrix}1 / 2 & 0 & Δ x \\ 0 & 1 / 2 & Δ y \\ 0 & 0 & 1 / 2\end{matrix} ) ,$$

and the three-dimensional coordinates (xₜ, yₜ, zₜ) of pixel points in the frame cache data corresponding to the second window are expressed as an equation (2):

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) . \qquad ( 2 )$$

It can be seen that, according to the embodiment, the application corresponding to the touch operation may be determined and the application may respond to the touch operation, according to the current touch operation and the priority information of the second window, in the case where there is the overlapping region of two or more second windows. Thus, a mass of operation may be avoided when multiple second windows are opened, and thereby the user experiment is improved.

Preferably, the second processing unit 92 is adapted to transform the starting coordinate and the ending coordinate of the operation in the first touch time, by using the first transformation matrix corresponding to the second window of the first application; and determining the transformed starting coordinate and the transformed ending coordinate of the operation as the first operation information corresponding to the first touch operation.

Preferably, the second processing unit 92 is adapted to determine operation type of the first touch operation, according to the transformed starting coordinate and the transformed ending coordinate in the first operation information; in the case where the operation type of the first touch operation is a clicking operation, determine that the first operation information is event coordinates for the selected first application, and generate response information for the event coordinates; and in the case where the operation type of the first operation information is a sliding operation, make a response by the first application according to the first operation information.

The second processing unit 92 is adapted to determine the operation type is the clicking operation, in the case where the starting coordinate and the ending coordinate of the operation are the same; determine the operation type is a sliding operation, in the case where the starting coordinate and the ending coordinate of the operation are different and the distance between the starting coordinate and the ending coordinate is larger than a preset threshold; and determine the operation type is a scaling operation, in the case where there are multiple touch operations and the distance between the starting coordinate and the ending coordinate of each of the touch operations is larger than a preset threshold.

Preferably, the second processing unit 92 is adapted to judge whether the first touch event is a transformation operation for the second window; in the case where the first touch event is the transformation operation for the second window, obtain the priorities of the transformation operations for the second windows from the priority information for the at least two second windows, and determine the application with a higher priority of the transformation operation for the second window as a first application; and

in the case where the first touch event is not the transformation operation for the second window, obtain the operation priority in the priority information for the at least two second windows, and determine the application with a higher priority as the first application.

In this way, the operation object of the first touch event may be selected according to the priority information corresponding to the second window of the application and the current first touch event. Thereby, the second window to be operated may be determined simply according to a gesture, and the user experience may be improved.

It should be understood that, in the embodiments according to the present application, the disclosed device and method may be implemented in other ways. The above-mentioned embodiments of the device according to the discloser are only illustrative. For example, the division in unit is only a logical division of functions and other kinds of division are possible in practice. For example, multiple units or components may be combined together or may be integrated in another system; or some features may be omitted or not implemented. Furthermore, the coupling, directly coupling or communication connection between the components shown or discussed may be indirectly coupling or communication connection between devices or units via some interfaces and may be electrical, mechanical or in other form.

The units described as separate components may be or may not be physically separated. The component displayed as the display unit may be or may not be a physical unit, i.e. may be located in one place or be distributed to multiple network units. The object of the solution of the embodiments may be achieved as required by some or all of the units.

Furthermore, the functional units in the embodiments of the disclosure may be all integrated in a processing unit; or the functional units may be each operates as a unit; or two or more of the functional units may be integrated in a unit. The integrated unit may be implemented in the form of hardware or in the form of hardware together with software.

The skill in the art may understand that: all or part of the steps achieving the above embodiment may be carried out by relevant hardware instructed by programs. The programs may be stored in a computer readable storage medium. The programs may implement the steps including the method of the above embodiment, when being executed. The aforementioned storage medium may include any medium which can store program code, such as a removable storage device, a read-only memory (ROM), a random access memory (RAM), a magnetic disk or an optical disk.

Alternatively, the above integrated unit in the disclosure which is implemented in the form of the software function module and which is sold and used as an individual product may also be stored in computer readable storage medium of a computer. On the basis of this understanding, the technical principle of the disclosure or the part of the disclosure contributing to the existing technologies may be embodied in a form of a software product which is stored in a storage medium and which include multiple instructions for instructing a computer device (which may be a personal computer, a server, a network equipment or the like) to perform all or part of the methods described in the embodiments of the disclosure. The storage medium may include any medium which can store program code, such as a removable storage device, a read-only memory (ROM), a random access memory (RAM), a magnetic disk or an optical disk.

Although it is disclosed above the disclosure by way of the specific embodiments of the disclosure, it should be understood that the scope of protection of the disclosure is not limited thereto. Various modifications and alternations may be made by those skilled in the art without deviation from the technical scope of the disclosure. Therefore, the scope of protection of the disclosure should be defined by the scope of protection of the appended claims.

1. An information processing method, applied to an electronic device with a touch display unit, M windows corresponding to M applications are displayed at the touch display unit, wherein M is a positive integer, the M windows includes at least one non-full-screen window, and the method comprises:
initiating an application of the M applications in a non-full-screen window, obtaining a first parameter, and transforming a first window of the application into a second window of the application by using the first parameter, wherein the first window is a full-screen window, and a display region of the second window is smaller than a display region of the full-screen window of the application;
presenting the second window of the application in the touch display unit;
detecting a first operation of a user to obtain a first event; and
in response to the first event, determining a target window from the M windows according to a preset rule, distributing the first event to the target window, where an application corresponding to the target window responds to the first operation.

2. The method according to claim 1, wherein the determining a target window from the M windows according to a preset rule comprises:
detecting interaction operations of the user with the M applications, and determining, as the target window, a window corresponding to an application on which the user performs the last interaction operation.

3. The method according to claim 2, wherein the detecting interaction operations of the user with the M applications, and determining, as the target window, a window corresponding to an application on which the user performs the last interaction operation by the user comprises:
detecting the interaction operations of the user with the M applications, establishing a window queue according to a sequence of the interaction operations, and updating the window queue in a timely manner; and
determining the last window in the window queue as the target window.

4. The method according to claim 3, wherein the detecting the interaction operations of the user with the M applications, establishing a window queue according to a sequence of the interaction operations, and updating the window queue in a timely manner comprises:
detecting the interaction operations of the user with the M applications, according to a location of a touch point detected in the region of the window of the application during the interaction operation of the user with the applications;
adding into the window queue a window on which the interaction operation is performed currently, in the case where the touch point is detected at the first time in the region of the window on which the interaction operation is performed currently;
not updating the window queue, in the case where the position of the touch point is detected to remain in the region of the window on which the interaction operation is performed currently; and
obtaining the location of the touch point, and adding a window with the location of the touch point into the window queue to update the window queue, in the case where the position of the touch point is detected to be outside the region of the window on which the interaction operation is performed currently.

5. The method according to claim 1, further comprising:
setting a window attribute of at least one window in the M windows to be a non-target window;
obtaining a control instruction for the interaction operation of the user with the M applications, wherein the control instruction is adapted to characterize a detection for the interaction operation to determine a target window from the M windows according to the window attribute; and
canceling a detection for a window corresponding to a current interaction operation during the detection for the interaction operation to determine a target window from the M windows, in the case where the window attribute of the window corresponding to the current interaction operation is detected to be the non-target window according to a predetermined parameter.

6. The method according to claim 1, wherein the second window comprises at least two second windows which have an overlapping region.

7. The method according to claim 6, wherein the first operation is a first touch operation; and
the detecting a first operation of a user to obtain a first event in the case where comprises:
detecting the first touch operation, and parsing the first touch operation for first touch event information to obtain location coordinates of the first touch operation; and
the in response to the first event, determining a target window from the M windows according to a preset rule, distributing the first event to the target window, where an application corresponding to the target window responds to the first operation comprises:
judging whether the first touch event information is located in the overlapping region of the at least two second windows, according to the location coordinates; and
if the first touch event information is located in the overlapping region of the at least two second windows, acquiring priority information corresponding to the at least two second windows; determining a first application to be response to the first touch operation according to the priority information; calculating first operation information corresponding to the first touch event information, from a first transformation matrix corresponding to the second window of the first application and the first touch event information; and responding to the first touch operation by the first application based on the first operation information.

8. The method according to claim 7, wherein the judging whether the first touch event information is located in the overlapping region of the at least two second windows according to the location coordinates further comprises;
if the first touch event information is not located in the overlapping region of the at least two second windows, determining that the first touch event information is located in a touch region of the second window of the first application; and calculating first operation information corresponding to the first touch operation, from the first transformation matrix corresponding to the second window of the first application and the first touch event information, wherein the first application responds to the first touch operation based on the first operation information.

9. The method according to claim 8, wherein the acquiring priority information corresponding to the at least two second windows, and determining a first application to be response to the first touch operation according to the priority information comprises:
acquiring priority information corresponding to the at least two second windows, wherein the priority information comprises a scaling operation priority and/or times for the last interaction operations of the at least two second windows; and
judging whether the first touch operation is a scaling operation; if the first touch operation is the scaling operation, determining an application with the highest scaling operation priority as the first application in response to the first touch operation, according to the scaling operation priorities of the at least two second windows; and if the first touch operation is not the scaling operation, extracting and comparing last operating times of the two second windows, and determining the application with the latest time for the last interaction operation as the first application for responding to the first touch operation.

10. The method according to claim 9, wherein the calculating first operation information corresponding to the first touch event information, from a first transformation matrix corresponding to the second window of the first application and the first touch event information comprises:
transforming a starting coordinate and an ending coordinate of the operation in the first touch event information, by using the first transformation matrix corresponding to the second window of the first application; and
determining the transformed starting coordinate and the transformed ending coordinate of the operation as the first operation information corresponding to the first touch operation.

11. The method according to claim 10, wherein the responding to the first touch event by the first application comprises:
determining an operation type of the first operation information, according to the transformed starting coordinate and the transformed ending coordinate;
in the case where the operation type of the first operation information is a clicking operation, determining that the first operation information is event coordinates for the selected first application, generating response information for the event coordinates, and executing the event corresponding to the event coordinates according to the first response information; and
in the case where the operation type of the first operation information is a sliding operation, responding to the first touch event by the first application according to the first operation information.

12. An electronic device, comprising a touch display unit, wherein the touch display unit comprises a display region, M windows corresponding to M applications are displayed at the display unit, wherein M is a positive integer, the M windows includes at least one non-full-screen window, and the electronic device further comprises:
a first processing unit adapted to initiate an application of the M applications in a non-full-screen window, obtain a first parameter, and transform a first window of the application by using the first parameter, wherein the first window is a full-screen window, and a display region of the second window is smaller than a display region of the full-screen window of the application;
the touch display unit adapted to present the second window of the application in the display region;
a first obtaining unit adapted to detect a first operation of a user to obtain a first event; and
a first response unit adapted to in response to the first event, determine a target window from the M windows according to a preset rule, and distribute the first event to the target window, where an application corresponding to the target window responds to the first operation.

13. The electronic device according to claim 12, wherein the first response unit is further adapted to detect interaction operations of the user with the M applications; and determine, as the target window, a window corresponding to an application on which the user performs the last interaction operation.

14. The electronic device according to claim 13, wherein the first response unit is further adapted to detect the interaction operations of the user with the M applications, establish a window queue according to a sequence of the interaction operations, and update the window queue in a timely manner; and determining the last window in the window queue as the target window.

15. The electronic device according to claim 14, wherein the first response unit is further adapted to detect the interaction operations of the user with the M applications, according to the location of a touch point detected in the region of the window of the application during the interaction operation of the user with the applications; adding into the window queue a window on which the interaction operation is performed currently, in the case where the touch point is detected at the first time in the region of the window on which the interaction operation is performed currently; not updating the window queue, in the case where the position of the touch point is detected to remain in the region of the window on which the interaction operation is performed currently; and obtaining the location of the touch point, and adding an window with the location of the touch point into the window queue to update the window queue, in the case where the position of the touch point is detected to be outside the region of the window on which the interaction operation is performed currently.

16. The electronic device according to claim 12, further comprising:
a setting unit adapted to set a window attribute of at least one window in the M windows to be a non-target window;
a control instruction obtaining unit adapted to obtain a control instruction for the interaction operation of the user with the M applications, wherein the control instruction is adapted to characterize a detection for the interaction operation to determine a target window from the M windows according to the window attribute; and
a second response unit adapted to cancel a detection for a window corresponding to a current interaction operation during the detection for the interaction operation to determine a target window from the M windows, in the case where the window attribute of the window corresponding to the current interaction operation is detected to be the non-target window according to a predetermined parameter.

17. The electronic device according to claim 12, wherein the second window comprises at least two second windows which have an overlapping region.

18. The electronic device according to claim 17, wherein the first operation is a first touch operation, the electronic device further comprises:
a second obtaining unit adapted to detect the first touch operation, and parse the first touch operation for first touch event information to obtain location coordinates of the first touch operation; and
a second processing unit adapted to judge whether the first touch event information is located in the overlapping region of the at least two second windows, according to the location coordinates; if the first touch event information is located in the overlapping region of the at least two second windows, acquire priority information corresponding to the at least two second windows; determine a first application to be response to the first touch operation according to the priority information; calculate first operation information corresponding to the first touch event information, from a first transformation matrix corresponding to the second window of the first application and the first touch event information, and responding to the first touch operation by the first application based on the first operation information.

19. The method according to claim 18, wherein
the second processing unit is further adapted to judge whether the first touch event information is located in the overlapping region of the at least two second windows according to the location coordinates; if the first touch event information is not located in the overlapping region of the at least two second windows, determine that the first touch event information is located in a touch region of the second window of the first application, and calculate first operation information corresponding to the first touch operation, from the first transformation matrix corresponding to the second window of the first application and the first touch event information, wherein the first application responds to the first touch operation.

20. The method according to claim 19, wherein
the second processing unit is adapted to acquire priority information corresponding to the at least two second windows, wherein the priority information comprises a scaling operation priority and/or times for the last interaction operations of the at least two second windows; and
judge whether the first touch operation is a scaling operation; if the first touch operation is the scaling operation, determine an application with the highest scaling operation priority as the first application in response to the first touch operation, according to the scaling operation priorities of the at least two second windows; and if the first touch operation is not the scaling operation, extract and compare last operating times of the at least two second windows, and determine the application with the latest time for the last interaction operation as the first application for responding to the first touch operation.

21. The method according to claim 20, wherein
the second processing unit is adapted to transform a starting coordinate and an ending coordinate of the operation in the first touch event information, by using the first transformation matrix corresponding to the second window of the first application; and determine the transformed starting coordinate and the transformed ending coordinate of the operation as the first operation information corresponding to the first touch operation.

22. The method according to claim 21, wherein
the second processing unit is adapted to determine an operation type of the first operation information, according to the transformed starting coordinate and the transformed ending coordinate;
in the case where the operation type of the first operation information is a clicking operation, determining that the first operation information is event coordinates for the selected first application, generate response information for the event coordinates, and execute the event corresponding to the event coordinates according to the first response information; and
in the case where the operation type of the first operation information is a sliding operation, respond to the first touch event by the first application according to the first operation information.
